(19) United States
(12) Patent Application Publication
(10) Pub. No.: US 2023/0096365 A1
(43) Pub. Date: Mar. 30, 2023

(54) VEHICULAR COMMUNICATION DEVICE

(71) Applicant: DENSO CORPORATION, Kariya-city (JP)

(72) Inventor: Seishin MIKAMI, Kariya-city (JP)

(21) Appl. No.: 18/075,635

(22) Filed: Dec. 6, 2022

Related U.S. Application Data
(63) Continuation of application No. PCT/JP2021/024022, filed on Jun. 24, 2021.

(30) Foreign Application Priority Data
Jul. 1, 2020 (JP) 2020-114416

(51) Int. Cl. H04B 7/185; H04B 7/12; H04B 7/0456

(52) U.S. Cl. CPC H04B 7/18595; H04B 7/12; H04B 7/0469

(57) ABSTRACT

A vehicular communication device is mounted on a vehicle and includes antenna elements, and a wireless circuit connected to the antenna elements and performing communication with another device using the antenna elements. Each antenna element of the antenna elements has a feeding point and a feeding direction in which the antenna element extends from the feeding point. The antenna elements include two antenna elements that are separated by a distance less than a predetermined coupling distance. Feeding directions of the two antenna elements are perpendicular to each other.

### CROSS REFERENCE TO RELATED APPLICATIONS

The present application is a continuation application of International Patent Application No. PCT/JP2021/024022 filed on Jun. 24, 2021, which designated the U.S. and claims the benefit of priority from Japanese Patent Application No. 2020-114416 filed on Jul. 1, 2020. The entire disclosures of all of the above applications are incorporated herein by reference.

### TECHNICAL FIELD

The present disclosure relates to a vehicular communication device including multiple antennas.

### BACKGROUND

A vehicular communication device is used on a roof of a vehicle and includes multiple antennas.

### SUMMARY

According to at least one embodiment of the present disclosure, a vehicular communication device is mounted on a vehicle, and includes antenna elements, and a wireless circuit connected to the antenna elements and performing communication with another device using the antenna elements. Each antenna element of the antenna elements has a feeding point and a feeding direction in which the antenna element extends from the feeding point. The antenna elements include two antenna elements that are separated by a distance less than a predetermined coupling distance. Feeding directions of the two antenna elements are perpendicular to each other.

### BRIEF DESCRIPTION OF DRAWINGS

The details of one or more embodiments are set forth in the accompanying drawings and the description below. Other features and advantages will be apparent from the description and drawings, and from the claims.

FIG. 1 is a diagram schematically showing a mounting position of a vehicular communication device on a vehicle.

FIG. 2 is a diagram showing a mounting orientation of the vehicular communication device.

FIG. 3 is a front view of a circuit board.

FIG. 4 is a side view of the circuit board.

FIG. 5 is a diagram showing a simulation model for obtaining a relationship between an inter-antenna distance and a correlation value.

FIG. 6 is a diagram showing a simulation result which is the relationship between the inter-antenna distance and the correlation value.

FIG. 7 is a diagram showing a simulation model for obtaining a relationship between a feeding direction and a correlation value.

FIG. 8 is a side view of the simulation model shown in FIG. 7.

FIG. 9 is a diagram showing another simulation model for obtaining the relationship between the feeding direction and the correlation value.

FIG. 10 is a side view of the simulation model shown in FIG. 9.

FIG. 11 is a diagram showing a simulation result which is the relationship between the feeding direction and the correlation value.

FIG. 12 is a diagram showing an entire configuration of a vehicular communication device 1 according to a second embodiment.

FIG. 13 is a front view of a circuit board.

FIG. 14 is a side view of the circuit board.

FIG. 15 is a diagram showing a simulation model for obtaining a relationship between a correlation value and an antenna bending amount.

FIG. 16 is a diagram showing a simulation result which is the relationship between the correlation value and the antenna bending amount.

FIG. 17 is a diagram showing an entire configuration of a vehicular communication device according to a third embodiment.

FIG. 18 is a front view of a circuit board.

FIG. 19 is a side view of the circuit board.

FIG. 20 is a diagram showing an entire configuration of a vehicular communication device according to a forth embodiment.

FIG. 21 is a front view of a circuit board.

FIG. 22 is a side view of the circuit board.

FIG. 23 is a diagram illustrating a vehicular communication device attached to a vehicle, according to a modification.

FIG. 24 is a diagram illustrating a vehicular communication device attached to a vehicle, according to a modification.

### DETAILED DESCRIPTIONS

To begin with, examples of relevant techniques will be described. According to a comparative example, a vehicular communication device is used on a roof of a vehicle and includes multiple antennas. Such antenna devices are used for, for example, MIMO (Multi Input Multi Output) type communication.

Further, in a mobile communications system, 5G has been put into practical use in recent years. 5G uses more frequency bands than those of current LTE/4G. For example, in 5G, a 3.7 GHz band, a 4.5 GHz band, and a 28 GHz band are added to the frequency bands used in 4G.

As described above, in recent mobile communications system, the number of frequency bands used for communication tends to increase. In response, there is a strong need for more antennas in the vehicular communication device to support multiple frequency bands.

As a number of antennas increases, the size of the device increases accordingly, which raises issues of cost and difficulty of mounting the device on a vehicle. Also, if antennas are arranged close to each other for miniaturization of the device, interference or coupling occurs between the antennas, thereby degrading communication performance.

In contrast to the comparative example, according to the present disclosure, while a vehicular communication device uses multiple antennas for performing communication, deterioration in communication performance can be reduced and the vehicular communication device can be miniaturized.

According to an aspect of the present disclosure, a vehicular communication device is, for example, mounted on a vehicle for use. The vehicular communication device incudes a wireless circuit for performing communication with another device by using multiple antenna elements. A distance between two of the antenna elements is less than a coupling distance, and the two antenna elements are provided to be perpendicular to each other in feeding direction which is an extending direction of an antenna element from its feed point.

According to the above configuration, feeding directions of the antenna elements placed in close proximity are perpendicular to each other. A correlation value between the antenna elements in which their feeding directions are perpendicular to each other tends to be reduced. That is, it is possible to miniaturize the vehicular communication device while reducing deterioration in communication performance.

Hereinafter, embodiments of the present disclosure will be described below with reference to the drawings. In the following, members having the same function will be assigned the same reference numeral, and the descriptions thereof will be omitted. When only a part of a configuration is described, the configuration described in the preceding embodiment can be applied to the other parts.

### First Embodiment

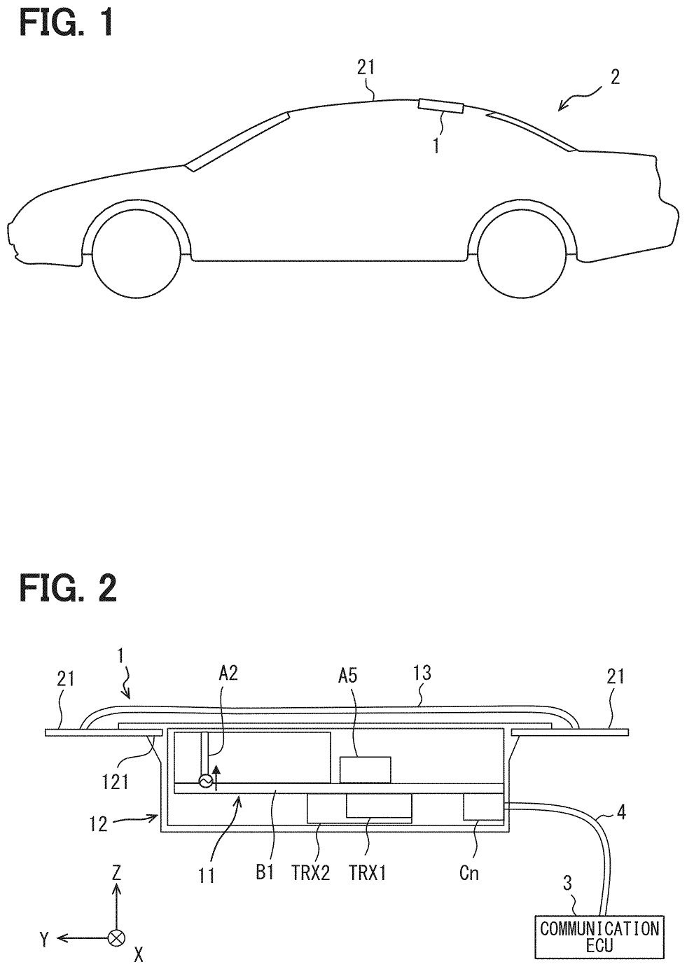

FIG. 1 is a diagram showing a mounting position and orientation of a vehicular communication device 1 on a vehicle 2. The vehicular communication device 1 is used while being attached to a roof 21 of the vehicle 2. For example, the vehicular communication device 1 can be arranged at a center of the roof 21 of the vehicle 2, or at a position shifted forward or backward from the center by a predetermined distance. For example, the vehicular communication device 1 is arranged at a rear end portion of an upper surface of the roof 21 of the vehicle 2. The predetermined distance can be set to a value between 0.1 m and 0.5 m. Further, the mounting position of the vehicular communication device 1 is not limited to the above. The mounting position of the vehicular communication device 1 may be near a front end of the roof 21. The upper surface of the roof 21 or an inner side of the roof 21 corresponds to a mounting surface for the vehicular communication device 1. The vehicular communication device 1 is mounted on the vehicle 2 by being fitted into a hole provided at a predetermined position on the roof 21.

In FIG. 1, as an example, the roof 21 of the vehicle 2 is gently slanted downward from a central portion toward the rear end portion. That is, the roof 21 becomes lower in a rearward direction of the vehicle 2. Of course, the roof shape of the vehicle 2 on which the vehicular communication device 1 is mounted is not limited to the shape shown in FIG. 1. The vehicular communication device 1 may be mounted on a vehicle that has a generally flat roof. The vehicular communication device 1 can be mounted on a vehicle having various outer shapes. For example, the vehicular communication device 1 can be mounted on a box type vehicle. The vehicle 2 shown in FIG. 1 is a normal passenger car, but the vehicular communication device 1 can be mounted on vehicles of various categories. For example, the vehicular communication device 1 can be mounted on trucks and buses.

The vehicular communication device 1 has multiple antennas that are configured to transmit and/or receive radio waves of a mobile communications system. For example, the vehicular communication device 1 is configured to be able to transmit and/or receive radio waves in a 2.5 GHz band, which is one of frequency bands assigned to a fifth-generation (so-called 5G) mobile communications system, using a MIMO method. MIMO is an abbreviation for multiple-input and multiple-output. The communication method using multiple antennas is not limited to the MIMO method, but may also be an antenna diversity method, beamforming method, etc. The configuration of the present disclosure can also be applied to a system/device that performs communication using an antenna diversity method, beam forming method, or the like.

Further, a frequency band used for transmission and reception of the vehicular communication device 1, i.e., an operating frequency band is not limited to the 2.5 GHz band. The operating frequency band may be appropriately designed. The operating frequency band may include a part or all of frequency bands of 700 MHz, 800 MHz, 900 MHz, 1.5 GHz, 1.7 GHz, 2 GHz, 2.5 GHz, 3.4 GHz, 3.7 GHz, 4.5 GHz, and 28 GHz. Further, the radio waves that the vehicular communication device 1 transmits and receives are not limited to radio waves allocated for 5G. The vehicular communication device 1 may be configured to transmit and receive radio waves allocated for 4G or LTE (Long Term Evolution). In addition, the vehicular communication device 1 may be configured to transmit and receive the radio waves allocated for a V2X communication system. For example, the 5.9 GHz band or the 700 MHz band may be used for the V2X communication system. Further, the vehicular communication device 1 may be configured to be able to perform either transmission or reception.

The vehicular communication device 1 includes, for example, a circuit board 11, a housing 12 that accommodates the circuit board 11, and a cover 13, as shown in FIG. 2. The circuit board 11 is a module in which various electronic components are mounted on a printed board B1. Details of the circuit board 11 are described separately below. A direction perpendicular to the circuit board 11 corresponds to an up-down direction for the vehicular communication device 1.

The housing 12 is shaped to accommodate the circuit board 11. For example, the housing 12 is formed in a flat rectangular parallelepiped shape. A direction perpendicular to the circuit board 11 corresponds to a thickness direction of the housing 12. The housing 12 has a box shape with a predetermined depth. The housing 12 is made of resin so as not to block radio waves. A side surface of the housing 12 has a fitting groove 121 for being fitted with an edge of the hole provided on the roof 21. The fitting groove 121 is arranged near an upper end of the side surface of the housing 12. According to this configuration, a protrusion height of the upper surface of the housing 12 relative to the upper surface of the roof 21 can be reduced. In order to improve waterproofness, the fitting groove 121 may be provided around side surfaces on an entire circumference of the housing 12. The fitting groove 121 may be arranged only in part around the side surfaces.

The cover 13 is a member that covers an entire top surface of the housing 12. The cover 13 is adhered to the roof 21 with an adhesive. The cover 13 is made of resin so as not to block radio waves. The cover 13 has a role to prevent water from entering a vehicle compartment through the hole that is provided on the roof 21 and fitted with the vehicular communication device 1. Further, the cover 13 has a role to protect the housing 12 and the circuit board 11 from flying objects such as sand and hail.

The vehicular communication device 1 is connected to a communication ECU (Electronic Control Unit) 3 via a communication cable 4. Signals received by the vehicular communication device 1 are sequentially output to the communication ECU 3. The vehicular communication device 1 converts electric signals input from the communication ECU 3 into radio waves, and emits the radio waves into space. The communication ECU 3 acquires signals received by the vehicular communication device 1, and outputs transmission signals or transmission data to the vehicular communication device 1. The communication cable 4 may be a coaxial cable, an Ethernet (registered trademark) cable, or the like. The vehicular communication device 1 and the communication ECU 3 may be configured to communicate wirelessly. A wireless communication method between the vehicular communication device 1 and the communication ECU 3 may be Bluetooth (registered trademark), Wi-Fi (registered trademark), or ZigBee (registered trademark), for example.

The vehicular communication device 1 is attached to the vehicle so that the circuit board 11 is parallel to the roof 21 and an antenna-mounted-surface faces upward. Here, the antenna-mounted-surface means a surface of the circuit board 11 on which various antennas are arranged. It should be noted that a state indicated by the expression “parallel” here is not limited to a completely parallel state. The expression “parallel” also includes a state inclined at an angle of from several degrees to several tens of degrees. Similarly, a state indicated by an expression “perpendicular” is not limited to a completely perpendicular state. The expression “perpendicular” also includes a state tilted by an angle of from several degrees to several tens of degrees. The vehicular communication device 1 has an up-down direction and a right-left direction depending on the mounting orientation of the vehicular communication device 1 on the vehicle.

<Configuration of Circuit Board 11>

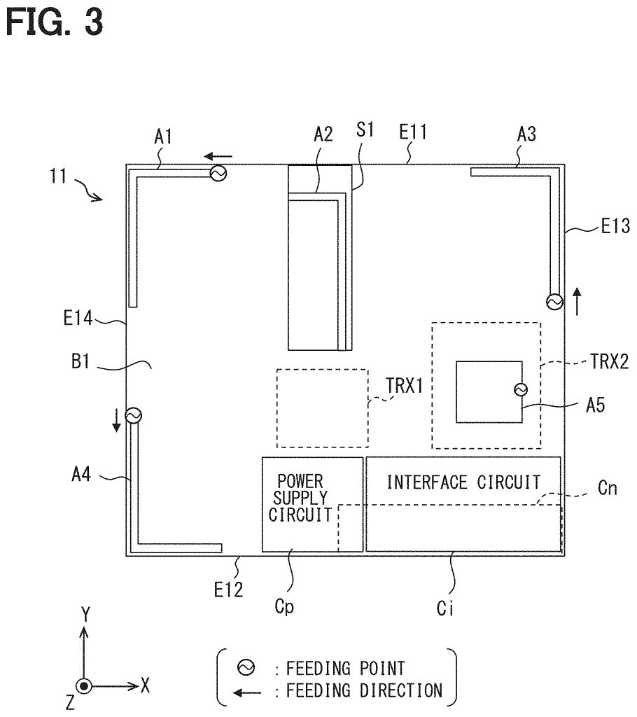

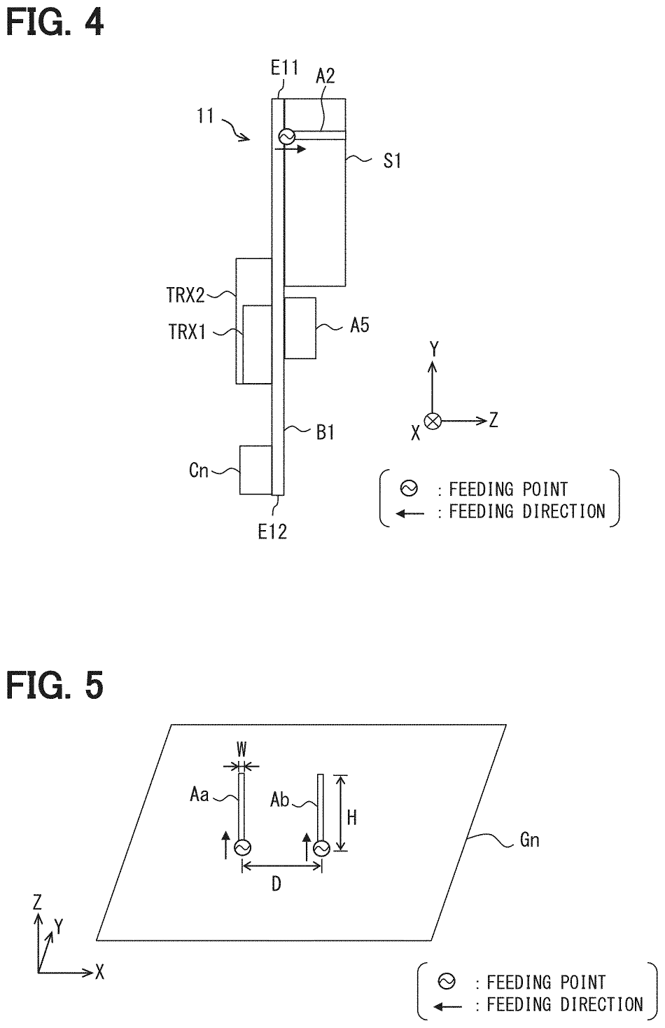

The following descriptions are about a configuration of the circuit board 11. FIG. 3 is a front view showing an example of a schematic configuration of the circuit board 11 according to the present embodiment. FIG. 4 is a side view of the circuit board 11. The circuit board 11 includes the printed board B1, antennas A1, A2, A3, A4, A5, wireless circuits TRX1, TRX2, a vehicle connector Cn, an interface circuit Ci, and a power supply circuit Cp.

In the following descriptions, “A” represents a target wavelength that is a wavelength of radio waves transmitted and received by the vehicular communication device 1. For example, “λ/2” and “0.5λ” refer to a half of the length of the target wavelength, and “λ/4” and “0.25λ” refer to the length of one quarter of the target wavelength. The wavelength of the 2.5 GHz radio wave (that is, λ) in vacuum and air is about 120 mm.

The printed board B1 is, for example, a multilayer board including multiple conductor layers and insulating layers. At least one internal conductor layer provided on the printed board B1 is configured to serve as a ground plate for the various antennas A1 to A5. The ground plate is a conductive plate that provides a ground potential. The ground plate is electrically connected to, for example, a ground terminal of the power supply circuit Cp, an outer conductor of the coaxial cable, or a ground side wire of a power cable. The conductor layer functioning as the ground plate can be called a ground layer. The conductor layer functioning as the ground plate may be formed on a lower surface of the printed board B1.

The printed board B1 has a rectangular shape, and it has an area that can accommodate various electronic components. The shape of the printed board B1 is not limited to the rectangle. The shape may be a trapezoidal shape or a square shape. An electrical length of a short side of the printed board B1 is set to 0.5λ, and an electrical length of a long side is set to 0.75λ. The electrical length here means a length in consideration of a wavelength shortening effect by dielectrics. The electrical length is also called an effective length. The dimensions of the printed board B1 described above are an example and can be changed as appropriate. The printed board B1 corresponds to an opposed substrate.

In the following, the configuration of the circuit board 11 will be described by introducing a concept of a right-handed three-dimensional coordinate system having mutually orthogonal X-, Y-, and Z-axes. An X-axis shown in various drawings such as FIG. 3 represents a longitudinal direction of the printed board B1, a Y-axis represents a lateral direction of the printed board B1, and a Z-axis represents the up-down direction. As another embodiment, if the printed board B1 has a square shape, a direction along any one side of the square shape can be the X-axis. The three-dimensional coordinate system including the X-, Y-, and Z-axes is a concept for describing the configuration of the vehicular communication device 1. For example, in a situation the vehicular communication device 1 is mounted on a vehicle, the X-axis corresponds to a right-left direction of the vehicle 2, the Y-axis corresponds to a front-rear direction of the vehicle 2, and the Z-axis corresponds to a height direction of the vehicle 2. An X-axis positive direction corresponds to a rightward direction of the vehicle 2 on which the vehicular communication device 1 is mounted. A Y-axis positive direction corresponds to a frontward direction of the vehicle 2. A Z-axis positive direction corresponds to an upward direction of the vehicle 2.

Hereinafter, one of edges of the printed board B1 parallel to the X-axis and facing in the Y-axis positive direction is referred to as a main-front-edge E11, and the other of the edges parallel to the X-axis and facing in a Y-axis negative direction is referred to as a main-rear-edge E12. Furthermore, one of edges of the printed board B1 parallel to the Y-axis and facing in the X-axis positive direction is referred to as a main-right-edge E13, and the other of the edges parallel to the Y-axis and facing in an X-axis negative direction is referred to as a main-left-edge E14.

The antennas A1 to A5, the interface circuit Ci, and the power supply circuit Cp are arranged on a surface of the printed board B1 on one side. As mentioned above, the surface of the printed board B1 of the circuit board 11 on which the antennas A1 to A5 are provided is the antenna-mounted-surface. Further, a surface of the printed board B1 opposite to the antenna-mounted-surface is referred to as a back surface. The antenna-mounted-surface corresponds to a surface facing upward when the vehicular communication device 1 is mounted on the vehicle 2. Therefore, the antenna-mounted-surface can also be called a top surface. The back surface corresponds to a surface facing downward when the vehicular communication device 1 is mounted on the vehicle 2. In other words, the back surface is a surface facing an interior of the vehicle 2. The back surface can also be called a bottom surface. The wireless circuits TRX1, TRX2 and the vehicle connector Cn are arranged on the back surface of the printed board B1. The back surface corresponds to a back surface portion.

The vehicle connector Cn is a component to be connected to the communication cable 4. The vehicle connector Cn is arranged on the back surface of the printed board B1 such that an end of the vehicle connector Cn facing in a longitudinal direction of the vehicle connector Cn is aligned with an end of the main-rear-edge E12 facing in the X-axis positive direction, and that the vehicle connector Cn extends along the main-rear-edge E12. In other words, the vehicle connector Cn is fixed at one corner of the printed board B1 so that the longitudinal direction of the vehicle connector Cn and the longitudinal direction of the printed board B1 are parallel. In this disclosure, the corner of the printed board B1 where the vehicle connector Cn is arranged is referred to as a connector-mounted-corner.

The interface circuit Ci is a set of circuits that performs signal processing for communication between the circuit board 11 and the communication ECU 3 via the vehicle connector Cn and the communication cable 4. For example, the interface circuit Ci includes a circuit for converting a signal format, a buffer circuit for temporarily storing received data, and another buffer circuit for temporarily storing transmitted data. The interface circuit Ci includes components (so-called I/O devices) that converts a logical signal into an actual electric signal in Ethernet (registered trademark) or UART, for example. Each of the I/O devices corresponding to various communication standards are often implemented as chipsets (so-called PHY chips). The interface circuit Ci may include a PHY chip of a predetermined communication standard. The interface circuit Ci is arranged on a backside of the vehicle connector Cn, that is, at the connector-mounted-corner on the antenna-mounted-surface of the printed board B1.

The power supply circuit Cp is a circuit module that converts a voltage supplied from a vehicle power supply into an operating voltage for each circuit and outputs the operating voltage. The power supply circuit Cp is also arranged near the interface circuit Ci. For example, the power supply circuit Cp is arranged along the main-rear-edge E12 on the antenna-mounted-surface so as to be adjacent to the interface circuit Ci in a direction along the X-axis. These configurations correspond to a configuration in which the power supply circuit Cp and the interface circuit Ci are arranged on the backside of the vehicle connector Cn. The interface circuit Ci and the power supply circuit Cp may be integrated. Since the interface circuit Ci and the power supply circuit Cp are significantly lower in height than the vehicle connector Cn, their illustration is omitted in FIG. 4.

Antennas A1, A2, A3, A4 are antennas for performing data communication with radio base stations that constitute the mobile communications system. The antennas A1 to A4 are antennas for receiving and/or transmitting radio waves in the 2.5 GHz band. The antennas A1 to A4 can also be called mobile-communication-antennas. The radio base stations are set on the ground. Therefore, it is preferable that the antennas A1 to A4 may be configured to be capable of transmitting and/or receiving radio waves in the horizontal direction. The radio base stations are often configured to transmit and/or receive vertically polarized waves. Therefore, any one of the antennas A1 to A4 may have a configuration suitable for transmitting and/or receiving vertically polarized waves. The configuration suitable for transmission and/or reception of vertically polarized waves is, for example, a monopole antenna provided perpendicularly to the printed board B1.

Each of the antennas A1 to A4 is configured to operate as the monopole antenna. Each of the antennas A1 to A4 includes a linear conductor having a length electrically corresponding to λ/4. Each of the antennas A1 to A4 has a bent shape that is bent at a right angle at a position away from a feeding point. Arrows in the drawings indicate feeding directions that are extending directions of the antennas A1 to A4 at their feeding points. A feeding direction of each antenna corresponds to a tangential direction of an antenna element of the antenna at its feeding point.

An antenna A1 among the antennas A1 to A4 is a reception-only antenna used for reception only. The antenna A1 is formed in an L-shaped pattern along a corner of the printed board B1 that is diagonally opposite to the connector-mounted-corner on the antenna-mounted-surface. The antenna A1 has a portion along the main-front-edge E11 and another portion along the main-left-edge E14. The portion of the antenna A1 along the main-front-edge E11 has an end facing in the X-axis positive direction and having a feeding point of the antenna A1. According to this configuration, a feeding direction of the antenna A1 is the same as the X-axis negative direction. When a linear antenna element is provided along an edge of the printed board B1, a gap less than a predetermined distance may exist between the edge of the printed board B1 and the antenna element. This predetermined distance can be set to, for example, 0.1λ.

An antenna A2 is a transmission and reception antenna used for both transmission and reception. The antenna A2 is standing on the printed board B1 in a central portion of the main-front-edge E11 of the antenna-mounted-surface by using a support portion S1. The support portion S1 is a component to support the antenna A2. The support portion S1 has, for example, a rectangular parallelepiped shape. The support portion S1 is made of resin. The antenna A2 extends along from a side surface of the support portion S1 to an upper surface of the support portion S1. The antenna A2 is bent at right angle at an edge of the upper surface of the support portion S1. That is, the antenna A2 has an upright section that is extending in the Z-axis positive direction along the side surface of the support portion S1, and a floating section that is extending along the upper surface of the support portion S1 so as to face the antenna-mounted-surface. The floating section of the antenna A2 includes an X-axis parallel portion that is extending in the X-axis positive direction from an upper end of the upright section, and a Y-axis parallel portion that is extending in the Y-axis negative direction from an end of the X-axis parallel portion that faces in the X-axis positive direction. A total length of the antenna A2 is set to electrically λ/4. A feeding point of the antenna A2 is arranged at a bottom part of the upright section. In other words, the feeding point of the antenna A2 is located on the printed board B1. According to this configuration, a feeding direction of the antenna A2 is the same as the Z-axis positive direction. As will be described later, the antenna A2 corresponds to an antenna that is arranged closest to a wireless circuit TRX1 among the antennas A1 to A4. Further, the antenna A2 corresponds to a tallest antenna among the antennas A1 to A4. The antenna A2 may have a stub or a short circuit for impedance matching. This is because an impedance of the antenna A2 may change according to a height of the antenna A2.

An antenna A3 is a reception-only antenna used for reception only. The antenna A3 is formed in an L-shaped pattern along a corner between the main-front-edge E1l and the main-right-edge E13 on the antenna-mounted-surface. The antenna A3 has a portion along the main-front-edge E11 and another portion along the main-right-edge E13. The portion of the antenna A3 along the main-right-edge E13 has an end facing in the Y-axis negative direction and having a feeding point of the antenna A3 is arranged at an end of. According to this configuration, a feeding direction of the antenna A3 is the same as the Y-axis positive direction.

An antenna A4 is a reception-only antenna used for reception only. The antenna A4 is formed in an L-shaped pattern along a corner between by the main-rear-edge E12 and the main-left-edge E14 on the antenna-mounted-surface. The antenna A4 has a portion along the main-rear-edge E12 and another portion along the main-left-edge E14. A feeding point of the antenna A4 is arranged at an end of the portion of the antenna A4 along the main-left-edge E14 facing in the Y-axis positive direction. According to this configuration, a feeding direction of the antenna A4 is the same as the Y-axis negative direction.

An antenna A5 receives navigation signals transmitted by navigation satellites of a GNSS (Global Navigation Satellite System). The antenna A5 can also be called a satellite-communication-antenna. Since the navigation satellites exist in the sky, the antenna A5 is an antenna that needs to receive electric waves from above the vehicle, i.e., in a direction from the zenith. The antenna A5 is configured as a patch antenna. A pair of diagonal corner portions of the antenna A5 may be truncated to function as degenerate separation elements, so that the antenna A5 can transmit and/or receive circularly polarized waves. The antenna A5 is arranged at a position shifted by a predetermined distance in the X-axis positive direction from a center of the printed board B1. In other words, the antenna A5 is arranged at a position shifted from the antenna A3 in the Y-axis negative direction. The above arrangement corresponds to a configuration in which the antenna A5 is arranged at a position separated by a predetermined distance from the antenna A2 having a three-dimensional structure. The above arrangement corresponds to a configuration in which the antenna A5 is located nearer to the antenna A3 having a two-dimensional structure than to the antenna A2 having the three-dimensional structure.

The wireless circuit TRX1 is a circuit module for receiving signals transmitted from other devices via the radio base stations and the antennas A1 to A4. The wireless circuit TRX1 is a circuit for execution of data communication. The wireless circuit TRX1 includes a circuit for performing predetermined signal processing on the signals received via the antennas A1 to A4 to extract received data, and another circuit for outputting transmission signals to the antenna A2. That is, the wireless circuit TRX1 may include a modulation circuit, a demodulation circuit, a detection circuit, a signal amplifier, a frequency converter, and a phase adjuster. The wireless circuit TRX1 is electrically connected to each of the antennas A1 to A4. The wireless circuit TRX1 is located within an area located at a center of the antennas A1 to A4 on the back surface of the printed board B1. For example, the wireless circuit TRX1 is arranged in a center portion of the back surface of the printed board B1. The above configuration, in other words, corresponds to a configuration in which the wireless circuit TRX1 is arranged at a position substantially equidistant from antennas A1, A3, and A4. Since the wireless circuit TRX1 is arranged in the center portion, the antenna A2 corresponds to an antenna that is arranged closest to the wireless circuit TRX1 among the antennas A1 to A4. Since the antenna A2 is also used for signal transmission and arranged near the wireless circuit TRX1, signal loss in transmission process can be reduced.

A wireless circuit TRX2 is a circuit for processing signals received from the satellites via the antenna A5. For example, the wireless circuit TRX2 is configured to function as a GNSS receiver that calculates a current position of the vehicular communication device 1 based on the signals from the satellites. The wireless circuit TRX2 is arranged behind the antenna A5.

<Relationship Between Inter-Antenna Distance and Correlation Value>

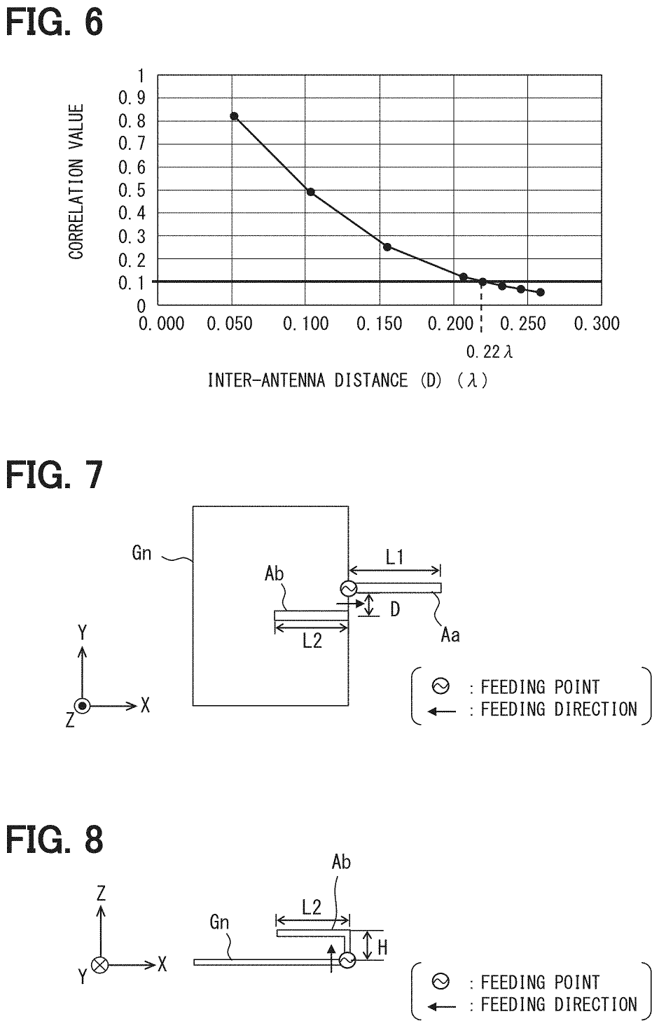

Here, a relationship between an inter-antenna distance and a correlation value will be described with reference to FIGS. 5 and 6. The correlation value is also called a correlation coefficient. In a field of communication technology where multiple antennas are used, it is generally known that a communication performance deteriorates as the correlation value increases. Thus, a smaller correlation value is more desirable.

FIG. 5 is a diagram showing a simulation model using two antennas Aa and Ab configured as monopole antennas. Both the antennas Aa and Ab are erected in the Z-axis positive direction, and feeding directions of the both antennas are the same as the Z-axis positive direction. A width “W” of a radiating element of each of the antennas Aa and Ab is set to 0.005λ. A height “H” of each of the antennas Aa and Ab is set to 0.25λ. A parameter “D” in FIG. 5 represents a distance between the antennas, in other words, the inter-antenna distance. In the above simulation model, a ground plate Gn is set to have a size sufficiently large relative to wavelengths of radio waves to be transmitted and received. In this disclosure, the inter-antenna distance corresponds to a distance between the feeding points of the respective antennas.

FIG. 6 shows simulation results of correlation values when the distance D between the antennas Aa and Ab is changed in the above model. As shown in FIG. 6, the smaller the distance between the antennas, the higher the correlation value. On the other hand, when the distance D is set at 0.22λ or more, the correlation value can be suppressed to 0.1 or less. Further, when the correlation value is 0.1 or less, a sufficient communication quality is expected to be obtained for a communication system using multiple antennas, such as an antenna diversity system or a MIMO system.

Paradoxically, FIG. 6 shows that when antennas having the same feeding direction are arranged to have the inter-antenna distance less than 0.22λ, the correlation value becomes 0.1 or more, and communication performance can be degraded. Hereinafter, a threshold value of the inter-antenna distance that can degrade the communication performance is also referred to as a coupling distance. For example, the coupling distance is set at 0.22λ. The coupling distance may be set at 0.25λ. Further, when an allowable range of the correlation value is up to 0.2, the coupling distance can be set at 0.175λ.

<Relationship Between Feeding Direction and Correlation Value>

Here, a relationship between a feeding direction and a correlation value will be described with reference to FIGS. 7 to 11. FIGS. 7 to 10 are diagrams showing simulation models using two antennas Aa and Ab configured as monopole antennas.

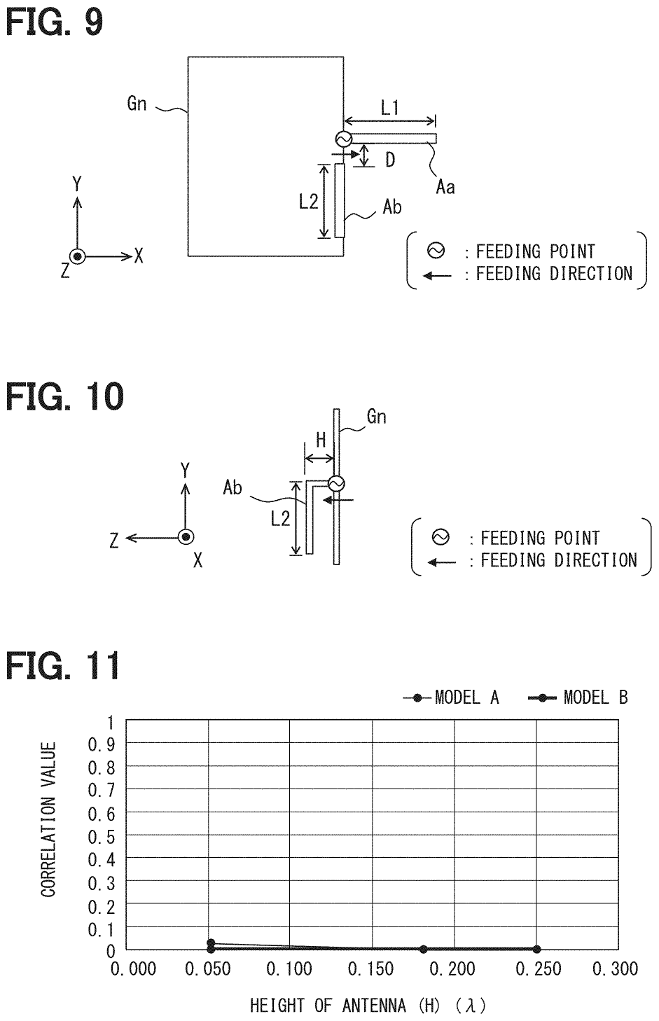

In the simulation models shown in both FIG. 7 and FIG. 9, the antenna Aa is a straight antenna in the X-axis direction, and the antenna Ab has an L-shape standing on the ground plate Gn. FIG. 8 schematically shows a configuration of the antenna Ab shown in FIG. 7 on the XZ plane. FIG. 10 shows a configuration of the antenna Ab shown in FIG. 9 on the YZ plane. A parameter L shown in FIGS. 7 and 9 represents a length of the antenna Aa and is set such that L≈λ/4. A parameter H shown in FIGS. 8 and 10 represents a height of the antenna Ab. The height H is a variable parameter in the simulations. A parameter L2 shown in FIGS. 8 and 10 represents a length of a portion of the antenna Ab that is parallel to the ground plate Gn. The antenna Ab is configured to satisfy H+L≈λ/4. The simulation model shown in FIGS. 7 and 8 is called a model A. The simulation model shown in FIGS. 9 and 10 is called a model B. In the model A, the antenna Ab is bent in a direction opposite to the antenna Aa. In the model B, the antenna Ab is bent in a direction perpendicular to the antenna Aa. In both models A and B, feeding directions of the antennas Aa and Ab are perpendicular. Further, a distance D between the antennas Aa and Ab is set to correspond to 0.1λ.

FIG. 11 shows simulation results of correlation values when the height H of the antenna Ab is changed in the model A and the model B. As shown in FIG. 11, the correlation values can be reduced to 0.1 or less regardless of the height H in both the model A and the model B. It has been confirmed that the above tendency is similar even when the distance D between the antennas Aa and Ab is changed in a range from 0.05λ to 0.25λ. That is, as long as the feeding directions are perpendicular, the correlation values can be reduced to 0.1 or less even when the inter-antenna distance D is less than or equal to the coupling distance.

Therefore, by designing a layout of the circuit board 11 based on following design ideas (1) and (2), the correlation value between the antennas can be reduced.

Idea (1): feeding directions of two antennas having an inter-antenna distance less than the coupling distance are perpendicular to each other.

Idea (2): antennas same as each other in feeding direction is separated by at least the coupling distance.

Based on the above design ideas (1) and (2), a communication performance is less likely to deteriorate due to changes in antenna positions and inter-antenna distance at time of designing of the circuit layout. As a result, an efficiency of the design process can be enhanced.

### Overview of First Embodiment

As one use case, the vehicular communication device 1 including the circuit board 11 configured as described above is placed on the roof 21 with the circuit board 11 substantially parallel to the horizontal plane of the vehicle. In this use case, the antenna A2 is highest in position among the antennas A1 to A4. In other words, the antenna A2 corresponds to an antenna element arranged at the best position for reception and transmission of radio waves among the antennas A1 to A4. Since the vehicular communication device 1 is configured to use the highest antenna A2 as a transmission and reception antenna, a communication performance can be easily ensured.

Further, there is a demand that the antenna A5 for satellite communication is exposed to the entire sky above. Regarding the demand, if a tall antenna such as the antenna A2 is located near the antenna A5, reception characteristics of the antenna A5 can be degraded by the antenna A2 in some directions. Considering the above issue, in the present embodiment, the antenna A5 is located closer to the short antenna A3 than to the tall antenna A2. According to this configuration, it is possible to reduce a possibility of the satellite-communication-antenna A5 having a radio blind spot. The radio blind spot is a direction in which radio signals cannot be received directly. The radio wave blind spot is also called non-line-of-sight for an antenna.

Further, the feeding direction of the antenna A1 is the same as the X-axis negative direction, and the feeding direction of the antenna A2 is the same as the Z-axis positive direction. Further, the feeding direction of the antenna A3 is the same as the Y-axis positive direction, and the feeding direction of the antenna A4 is the same as the Y-axis negative direction. In the above configuration, the feed directions of two antennas having the inter-antenna distance less than the predetermined coupling distance are set to be perpendicular. Specifically, the antennas A1 and A2, the antennas A2 and A3, and the antennas A1 and A4 are perpendicular to each other in feeding directions.

As long as the feeding directions of the two antennas are perpendicular, the correlation values of these antennas can be reduced to a predetermined value (e.g., 0.1 or less) even if the distance between the antennas is less than the coupling distance. That is, two antennas can be located closer without deterioration in communication performance. As a result, it is possible to reduce a size of the circuit board B1.

Further, according to the above configuration, the antennas A1 to A4 for mobile communication can be arranged closer to each other. As a result, the antennas A1 to A4 for mobile communication and the wireless circuit TRX1 for processing signals received by these antennas can be accommodated in one case. In addition, a size of the vehicular communication device 1, in particular, the height thereof can be reduced. Furthermore, since the vehicular communication device 1 is miniaturized, ease of attachment of the vehicular communication device 1 to the vehicle 2 can also be improved.

In addition, as described above, the feeding direction of each antenna is determined before designing a circuit layout. Hence, an impact on a communication performance can be reduced even if the antenna position or the inter-antenna distance is changed at a stage of modification of the circuit layout. Therefore, even if fine-tune of the circuit layout is required due to adding a new component to the circuit board, it is possible to reduce costs of redesigning shapes and/or positions of antennas. In other words, it is possible to reduce design man-hours for determining a configuration suitable for a communication system using multiple antennas.

Furthermore, the above configuration makes it easier to achieve a required communication performance while accommodating the multiple antennas A1 to A4 in one case. Therefore, there is no need to provide another antenna for mobile communication at another location on the vehicle 2 in order to obtain the required communication performance. Along with this, it becomes possible to reduce a number of coaxial connectors connected to the communication ECU or the wireless circuit TRX1. As a result, it is possible to reduce costs such as work time to attach the vehicular communication device 1 to the vehicle 2.

Furthermore, by forming the antennas A1 to A4 in a bent shape such as an L shape, further miniaturization of the vehicular communication device 1 is possible. In particular, the height of the vehicular communication device 1 can be reduced by forming the antenna A2 erected on the printed board B1 into a bent shape in which the antenna A2 is bent twice. As a result, an amount of protrusion of the vehicular communication device 1 from the upper surface of the roof 21 can be reduced.

### Second Embodiment

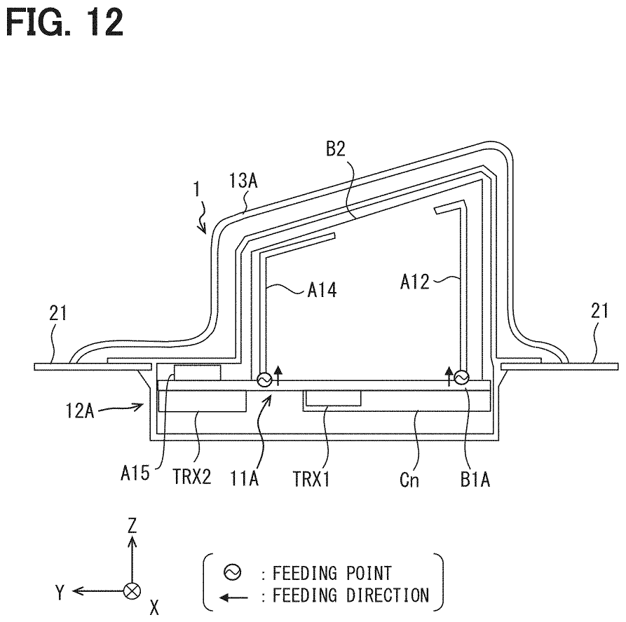

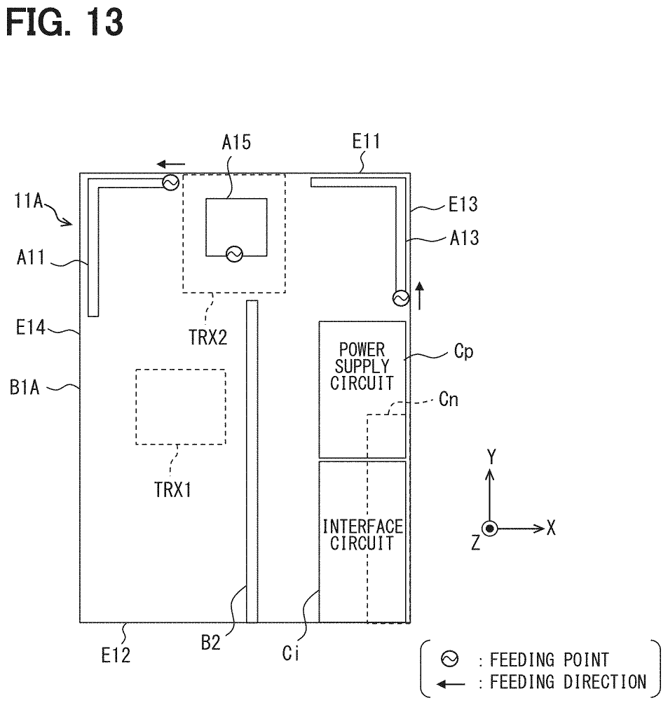

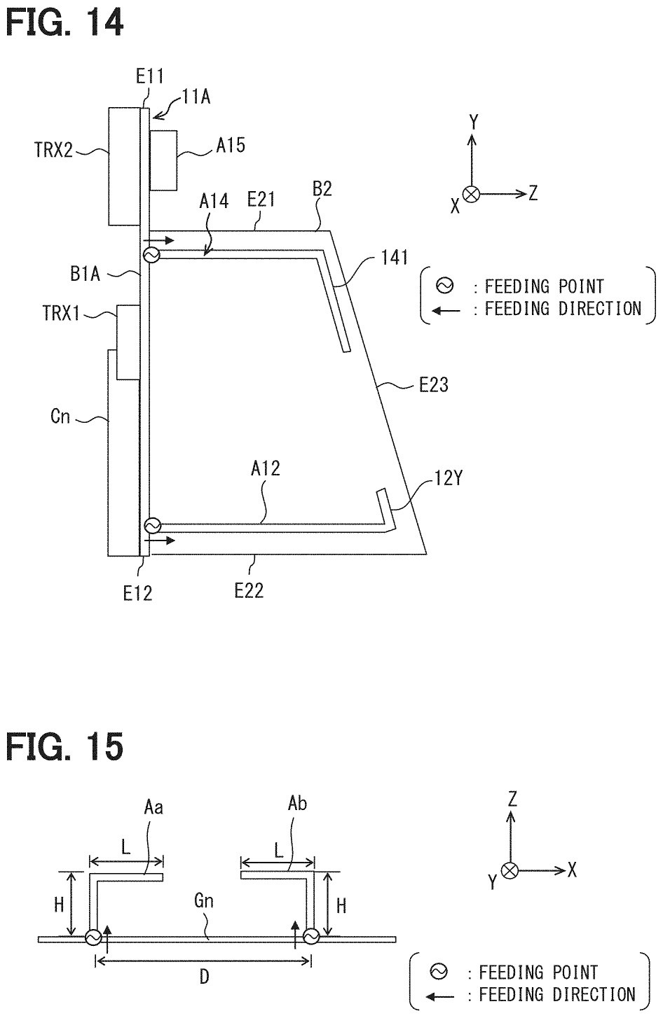

Hereinafter, a vehicular communication device 1 of a second embodiment of the present disclosure will be described with reference to FIGS. 12 to 16. FIG. 12 is a diagram schematically showing an entire configuration of the vehicular communication device 1 according to the second embodiment. FIG. 13 is a front view of a circuit board 11A according to the second embodiment, and FIG. 14 is a side view of the vehicular communication device 1 according to the second embodiment.

The main difference between the second embodiment and the first embodiment is, as shown in FIG. 12, an exterior shape of the vehicular communication device 1. In the second embodiment, the exterior shape of the vehicular communication device 1 is formed in a so-called shark fin shape that is streamlined to reduce air resistance during running of a vehicle. In other words, the shark fin shape corresponds to a three-dimensional shape formed so that a thickness is smaller than a length in the front-rear direction, and a height increases gently from a front end to a rear end. The shark fin shape can also be called a dolphin shape. The second embodiment may be understood as a modification of the first embodiment.

The vehicular communication device 1 according to the second embodiment will be described. The vehicular communication device 1 of the second embodiment includes the circuit board 11A, a housing 12A, and a cover 13A. The cover 13A is shaped like a shark fin as described above. The housing 12A has a shape large enough to accommodate the circuit board 11A including a sub-board B2 erected vertically on a main-board B1A. That is, the housing 12A also has a substantially shark fin shape protruding upward.

The circuit board 11A includes the main-board B1A corresponding to the printed board B1, the sub-board B2, antennas A11, A12, A13, A14, A15, wireless circuits TRX1, TRX2, a vehicle connector Cn, an interface circuit Ci, and a power supply circuit Cp.

The main-board B1A is a rectangular printed board a longitudinal direction of which is parallel to a Y-axis direction. The main-board B1A is configured as a multilayer board including multiple conductor layers and insulating layers. At least one internal conductor layer provided in the main-board B1A is configured to serve as a ground plate for the antennas A11 to A15. An electrical length in an X-axis direction of the main-board B1A is set to 0.4λ, and an electrical length in a Y-axis direction is set to 0.7λ. The dimensions of the main-board B1A can be changed as appropriate. The length in the Y-axis direction of the main-board B1A may be set to 0.5λ or more.

The sub-board B2 is a plate-like member attached perpendicularly to the main-board B1A. For example, the sub-board B2 is implemented using a printed board. The sub-board B2 may be simply a resin plate. The sub-board B2 is erected on an antenna-mounted-surface along a center line of the main-board B1A that passes through a center thereof and is parallel to the Y-axis. The sub-board B2 is attached to the antenna-mounted-surface of the main-board B1A in an orientation parallel to a YZ plane. The sub-board B2 is formed so that its height increases from an end portion facing in a Y-axis positive direction toward another end portion facing in a Y-axis negative direction. A shape of the sub-board B2 may be a right-angled trapezoid or a triangle. Alternatively, an edge of the sub-board B2 facing in a Z-axis positive direction may be formed in a curved shape. Here, as shown in FIG. 14, the sub-board B2 is formed in the right-angled trapezoid. The sub-board B2 corresponds to a vertical plate.

Hereinafter, for simplification of explanation, an edge of the sub-board B2 facing in the Y-axis positive direction is referred to as a sub-front-edge E21. This is because the Y-axis positive direction corresponds to a frontward direction of a vehicle when the vehicular communication device 1 is mounted on the vehicle. Since the Y-axis negative direction corresponds to a rearward direction of the vehicle, an edge of the sub-board B2 facing in the Y-axis negative direction is referred to as a sub-rear-edge E22. Further, since the Z-axis positive direction corresponds to the upward direction of the vehicle, an edge of the sub-board B2 facing in the Z-axis positive direction is referred to as a sub-upper-edge E23. An edge of the sub-board B2 facing in a Z-axis negative direction is referred to as a sub-lower-edge. The sub-lower-edge corresponds to a joint portion with the main-board B1A. One of two surfaces of the sub-board B2 facing in an X-axis negative direction is also referred to as a left-side-surface, and the other surface facing in an X-axis positive direction is referred to as a right-side-surface.

A length of the sub-board B2 in the Y-axis direction can be appropriately set within a range smaller than a length of the main-board B1A in the Y-axis direction. For example, the electrical length of the sub-board B2 in the Y-axis direction is set to 0.4λ. The electrical length of the sub-board B2 in the Y-axis direction may be set to 0.22λ or more.

A length of the sub-board B2 in the Z-axis direction, i.e., a height thereof, is configured to gradually increase in the Y-axis negative direction. A length of the sub-front-edge E21 is set to a value electrically corresponding to 0.15λ, for example. A length of the sub-rear-edge E22 is set to a value electrically corresponding to 0.2λ, for example. The dimensions above are examples and can be changed as appropriate. For example, a length of an end portion of the sub-board B2 facing in the Y-axis positive direction may be equivalent to 0.1λ or 0.2λ. The sub-rear-edge E22 is at least longer than the sub-front-edge E21. From a viewpoint of reducing a height of the vehicular communication device 1, the sub-board B2 may be formed as low as possible.

The vehicle connector Cn is arranged on a back surface of the main-board B1A such that an end of the vehicle connector Cn facing in a longitudinal direction of the vehicle connector Cn is aligned with a main-rear-edge E12 and that the vehicle connector Cn extends along a main-right-edge E13. The interface circuit Ci is arranged on a backside of the vehicle connector Cn, that is, at a connector-mounted-corner on the antenna-mounted-surface of the main-board B1λ. The vehicle connector Cn corresponds to a largest component among components mounted on the main-board B1λ. Since the vehicle connector Cn is arranged in an orientation along the Y-axis direction, a width of the main-board B1A in the X-axis direction can be reduced. As the result, ease of attachment of the vehicular communication device 1 to the vehicle 2 can also be improved. The interface circuit Ci is arranged between the main-right-edge E13 and the sub-board B2 on the antenna-mounted-surface.

The power supply circuit Cp is arranged near the interface circuit Ci. For example, the power supply circuit Cp is arranged between the main-right-edge E13 and the sub-board B2 on the antenna-mounted-surface, so as to be adjacent to the interface circuit Ci in the Y-axis direction. Illustrations of the interface circuit Ci and the power supply circuit Cp are omitted in FIG. 14.

Antennas A11, A12, A13, A14 are antennas for performing data communication with radio base stations that constitute a mobile communications system. The antennas A11 to A14 have configurations corresponding to the antennas A1 to A4 described above. Each of the antennas A11 to A14 is configured to function as a monopole antenna.

An antenna A11 is a reception-only antenna used for reception only. The antenna A11 is formed in an L-shaped pattern along a corner that is diagonally opposite to the connector-mounted-corner on the antenna-mounted-surface. The antenna A11 has a portion along a main-front-edge E11 and another portion along a main-left-edge E14. The portion of the antenna A11 along the main-front-edge E11 has an end facing in the X-axis positive direction and having a feeding point of the antenna A11. According to this configuration, a feeding direction of the antenna A11 is the same as the X-axis negative direction.

An antenna A12 is a transmission and reception antenna used for both transmission and reception. The antenna A12, for example, extends from the sub-lower-edge toward the sub-upper-edge E23 along the sub-rear-edge E22 on the left-side-surface of the sub-board B2. In other words, the antenna A12 extends perpendicularly to the main-board B1A. Further, the antenna A12 has a shape bent near the sub-upper-edge E23 toward the Y-axis positive direction along the sub-upper-edge E23. That is, the antenna A12 has an upright section extending along the sub-rear-edge E22 from the joint portion with the main-board B1A, and an extended section 12Y extending along the sub-upper-edge E23. A total electrical length of the antenna A12 is set to λ/4. A feeding point of the antenna A12 is arranged at a bottom part of the upright section. In other words, the feeding point of the antenna A12 is located at an end of the antenna A12 facing in the Z-axis negative direction. According to this configuration, a feeding direction of the antenna A12 is the same as the Z-axis positive direction. Further, the antenna A12 corresponds to a tallest antenna among the antennas A11 to A14.

An antenna A13 is a reception-only antenna used for reception only. The antenna A13 is formed in an L-shaped pattern along a corner between the main-front-edge E11 and the main-right-edge E13 on the antenna-mounted-surface. The antenna A13 has a portion along the main-front-edge E11 and another portion along the main-right-edge E13. The portion of the antenna A13 along the main-right-edge E13 has an end facing in the Y-axis negative direction and having a feeding point of the antenna A13. According to this configuration, a feeding direction of the antenna A13 is the same as the Y-axis positive direction. A distance between the feeding point of the antenna A13 and the feeding point of the antenna A11 may be less than the coupling distance because these feeding directions are perpendicular each other.

An antenna A14 is a reception-only antenna used for reception only. The antenna A14, for example, extends from the sub-lower-edge toward the sub-upper-edge E23 along the sub-front-edge E21 on the left-side-surface of the sub-board B2. In other words, the antenna A14 extends perpendicularly to the main-board B1λ. Further, the antenna A14 has a shape bent near the sub-upper-edge E23 toward the Y-axis negative direction along the sub-upper-edge E23. That is, the antenna A14 has an upright section extending along the sub-front-edge E21 from the joint portion with the main-board B1λ, and an extended section 141 extending along the sub-upper-edge E23. A total electrical length of the antenna A14 is set to λ/4. A feeding point of the antenna A14 is located at an end of the antenna A14 facing in the Z-axis negative direction. In other words, the feeding point of the antenna A14 is arranged at the joint portion between the sub-board B2 and the main-board B1λ. According to this configuration, a feeding direction of the antenna A14 is the same as the Z-axis positive direction.

A distance between the feeding points of antennas A14 and A11 may be less than the coupling distance because these feeding directions are perpendicular to each other. A distance between the feeding points of antennas A14 and A13 may be less than the coupling distance because these feeding directions are perpendicular each other.

Further, both antennas A12 and A14 are mounted on the sub-board B2, and their feeding directions are the same. However, the antenna A12 is arranged along the sub-rear-edge E22, and the antenna A14 is arranged along the sub-front-edge E21. Since the electrical length of the sub-board B2 in the Y-axis direction is set to λ/4 or more, an electrical distance between the antennas A12 and A14 is also 0.22λ or more. According to this configuration, the correlation value between the antennas A12 and A14 can be reduced to 0.1 or less.

An antenna A15 is a component corresponding to the antenna A5. The antenna A15 is arranged at a position shifted from the sub-board B2 in the Y-axis positive direction and located in a central portion of the main-board B1A in the X-axis direction. In other words, the antenna A15 is arranged between the antenna A11 and the antenna A13.

A wireless circuit TRX1 is electrically connected to each of the antennas A11 to A14. The wireless circuit TRX1 is arranged at a position shifted by a predetermined distance in the X-axis negative direction from a center of the main-board B1A on the back surface thereof. In other words, the wireless circuit TRX1 is arranged between the sub-board B2 and the main-left-edge E14. This arrangement of the wireless circuit TRX1 is just an example, and the wireless circuit TRX1 may be arranged at a position overlapping the sub-board B2 on the back surface of the main-board B1A. Moreover, the wireless circuit TRX1 may be arranged at a position where a total value of distances from each of the antennas A11 to A14 is minimized. According to this configuration, transmission loss in the entire device can be reduced. Furthermore, the wireless circuit TRX1 may be arranged near antenna A12, which is used for signal transmission. When the antenna A12 used for signal transmission is arranged near the wireless circuit TRX1, signal loss in transmission process can be reduced. In addition, the wireless circuit TRX1 may be arranged at a location corresponding to a center of gravity of feeding points of the antennas A11-14.

A wireless circuit TRX2 is a circuit for processing signals received from the satellites via the antenna A15. The wireless circuit TRX2 is arranged behind the antenna A15.

<Influence of L-Shaped Antennas Extending in Z-Axis Direction>

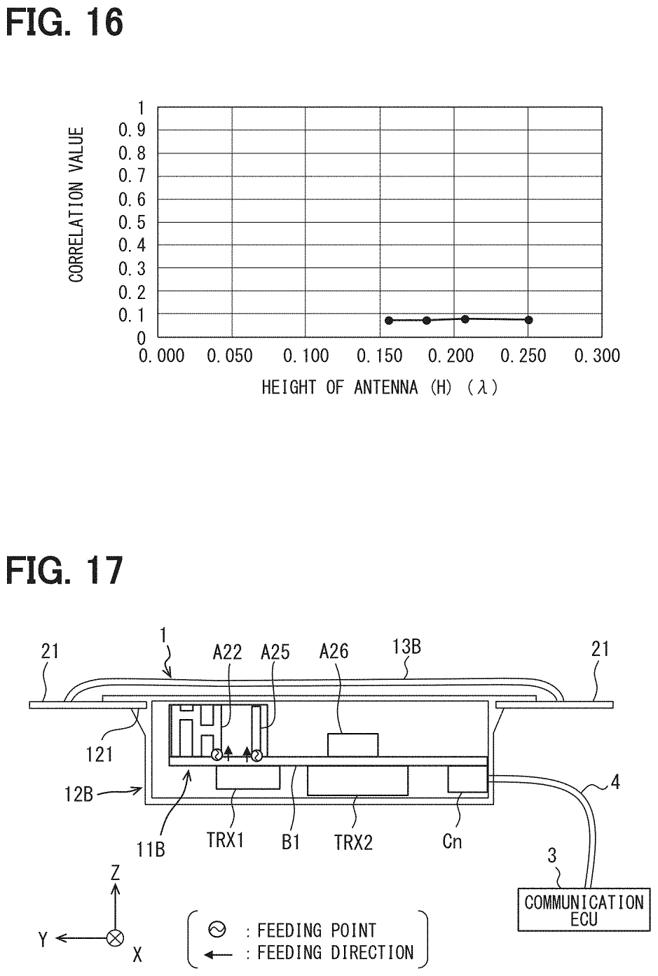

The antennas A12 and A14 form a combination of antennas having L shapes extending in a Z-axis direction and bent. Here, an influence of such combination on the correlation value will be described with reference to FIGS. 15 and 16. It should be noted that the L-shape here is not limited to a shape bent at a right angle. The L-shape includes a bent shape in which a bending angle is set from 30° to 150°. The bending angle means an interior angle at a bent portion.

FIG. 15 shows a simulation model including L-shaped antennas Aa and Ab erected on a ground plate Gn. A parameter L shown in FIG. 15 represents a length of a portion of each of the antennas Aa and Ab parallel to the ground plate Gn. A parameter H in FIG. 15 represents a height of each of the antennas Aa and Ab. Both of the antennas Aa and Ab are configured to satisfy H+L≈λ/4. A distance D between the antennas Aa and Ab is set to correspond to 0.23λ. An antenna Aa is bent toward an antenna Ab, and an antenna Ab is bent toward the antenna Aa. That is, the antennas Aa and Ab have structures bent toward each other. A feeding direction of each of the antennas Aa and Ab is the same as the Z-axis positive direction. That is, the antennas Aa and Ab are same as each other in feeding direction.

FIG. 16 shows simulation results of correlation values when heights H of the antennas Aa and Ab are changed, while the inter-antenna distance D is kept constant in the simulation model shown in FIG. 15. As shown in FIG. 16, the correlation values can be reduced to 0.1 or less regardless of the heights H. It has been confirmed that the similar tendency is shown even when the distance D between the antennas Aa and Ab is set 0.22λ or more. That is, even if the antennas Aa and Ab are bent, a relationship between the inter-antenna distance D and the correlation value is similar to the relationship described with reference to FIGS. 5 and 6.

Therefore, while the correlation value is kept low, a height of the vehicular communication device 1 can be reduced by a configuration in which two antennas, such as the antennas A12 and A14, extend in the Z-axis direction and are bent, as long as the inter-antenna distance is equal to or greater than the coupling distance.

### Overview of Second Embodiment

The feeding direction of the antenna A11 is the X-axis negative direction, the feeding direction of the antenna A12 is the Z-axis positive direction, the feeding direction of the antenna A13 is the Y-axis positive direction, and the feeding direction of the antenna A14 is the X-axis positive direction. Since the antennas A11 and A14, and the antennas A13 and A14 are perpendicular to each other in feeding directions, the correlation values of these antennas can be reduced to 0.1 or less even if inter-antenna distances are less than the coupling distance. That is, it is possible to reduce a size of the vehicular communication device 1 without deterioration in communication performance.

The feeding directions of the antennas A12 and A14 are the same as the Z-axis positive direction, i.e. the same as each other. However, the correlation value of these antennas can be reduced to 0.1 or less because their inter-antenna distance is set to the coupling distance or more. That is, it is possible to reduce degradation in communication performance. Further, since the antennas A12 and A14 extending in the Z-axis positive direction are bent, the height of each of the antennas and the height of the vehicular communication device 1 can be reduced without degrading the communication performance.

The antenna A12 corresponds to a tallest antenna among the antennas A11 to A14 for mobile communication. The antenna A12 is mounted perpendicularly to the main-board B1A. When the vehicular communication device 1 is attached to the roof 21 with the main-board B1A being substantially parallel to the ground, as shown in FIG. 12, the antenna A12 is located at a highest position, in other words, a best position for reception and transmission of radio waves among the antennas A11 to A14. Therefore, qualities of transmitted signals can be improved by using the antenna A12 as a transmission and reception antenna.

Further, the antenna A15 for satellite communication is located away from the tallest antenna A12. According to this configuration, it is possible to reduce a radio blind spot of the antenna A15 caused by the antenna A12. In addition, according to the above configuration, the same effects as those of the first embodiment can be obtained.

### Third Embodiment

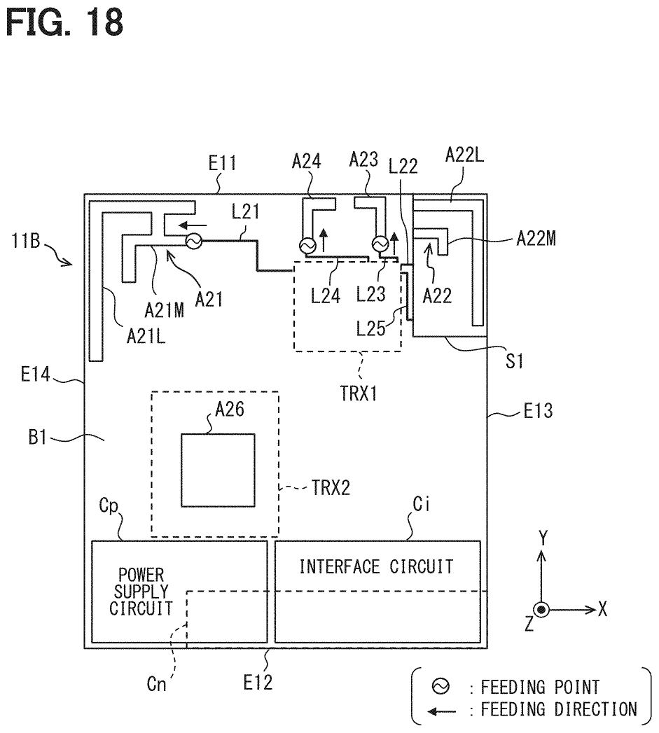

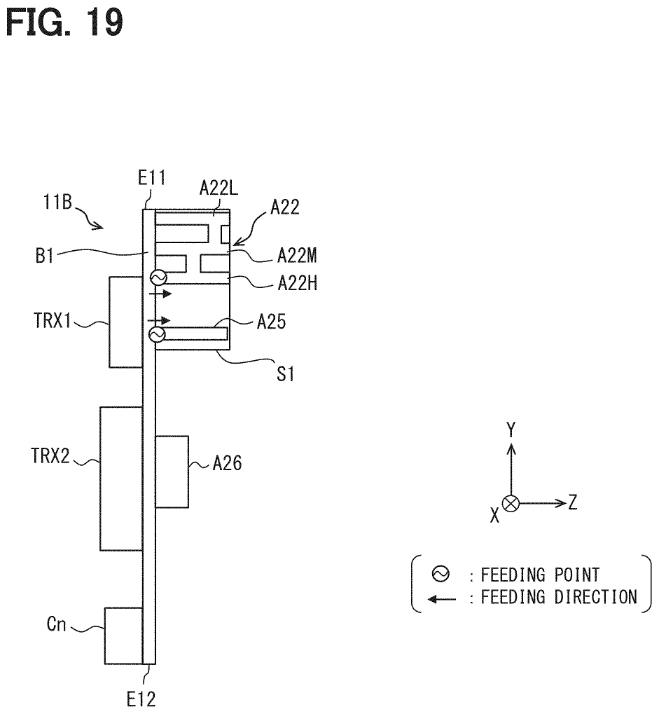

Hereinafter, a vehicular communication device of a third embodiment of the present disclosure will be described with reference to FIGS. 17 to 19. FIG. 17 is a diagram showing a state in which the vehicular communication device 1 is mounted on a roof of a vehicle in the third embodiment. FIG. 18 is a front view of a circuit board 11B according to the third embodiment, and FIG. 19 is a side view of the circuit board 11B according to the third embodiment. A third embodiment is a modification of the first embodiment.

A difference between the third embodiment and the first embodiment is that the vehicular communication device 1 of the third embodiment is configured to be able to transmit and receive radio waves in multiple frequency bands. In other words, the vehicular communication device 1 in the third embodiment has antennas with different frequency bands for transmitting and receiving. A frequency band is also simply called a band.

Here, as an example, the vehicular communication device 1 is configured to be able to transmit/receive radio waves in three frequency bands: a high band, a middle band, and a low band. The low band is a lowest frequency band of the three frequency bands. For example, the low band may be a 1.5 GHz band. The middle band is a second lowest frequency band of the three frequency bands. For example, the middle band may be a 2.5 GHz band. The high band is a highest frequency band of the three frequency bands. For example, the high band may be a 4.5 GHz band. The frequency bands and a number of bands for transmission and reception can be changed as appropriate. For example, the high band may be the 3.7 GHz band.

Hereinafter, λH represents a wavelength of radio waves in the high band, λM represents a wavelength of radio waves in the middle band, and λL represents a wavelength of radio waves in the low band. A wavelength of radio waves in a certain frequency band may be a wavelength of a center frequency of the frequency band.

As shown in FIG. 17, the vehicular communication device 1 in the third embodiment includes the circuit board 11B, a housing 12B, and a cover 13B. Configurations of the housing 12B and the cover 13B may be the same configurations as the housing 12 and the cover 13 in the first embodiment.

The circuit board 11B includes a printed board B1, antennas A21, A22, A23, A24, A25, A26, wireless circuits TRX1, TRX2, a vehicle connector Cn, an interface circuit Ci, and a power supply circuit Cp. FIG. 18 shows a configuration in which a Y-axis direction is set to a longitudinal direction of the printed board B1, as an example. A length of the printed board B1 in an X-axis direction may be configured to longer than a length of the printed board B1 in the Y-axis direction. The length of the printed board B1 in the X-axis direction is set to correspond to 0.4λ, and the length of the printed board B1 in the Y-axis direction is set to correspond to 0.7λ. The dimensions of the printed board B1 can be changed as appropriate.

The vehicle connector Cn is arranged on a back surface of the printed board B1 such that an end of the vehicle connector Cn facing in a longitudinal direction of the vehicle connector Cn is aligned with an end of a main-right-edge E13 and that the vehicle connector Cn extends along a main-rear-edge E12. The interface circuit Ci is arranged on a backside of the vehicle connector Cn, that is, at a connector-mounted-corner on an antenna-mounted-surface of the printed board B1.

The power supply circuit Cp is located adjacent to the interface circuit Ci. For example, the power supply circuit Cp extends from a main-left-edge E14 toward an X-axis positive direction on the antenna-mounted-surface, so as to be adjacent to the interface circuit Ci in the Y-axis direction. Illustrations of the interface circuit Ci and the power supply circuit Cp are omitted in the FIG. 19. The positions of the interface circuit Ci and the power supply circuit Cp can be interchanged. The interface circuit Ci and the power supply circuit Cp may be integrated, or may share some components.

Antennas A21, A22, A23, A24, A25 are antennas for performing data communication with radio base stations that constitute a mobile communications system. Among the antennas A21 to A25, an antenna A21 is configured as a dual-band antenna which is used for reception only, and supporting the low band and the middle band. For example, the antenna A21 is patterned along a corner diagonally opposite to the connector-mounted-corner on the antenna-mounted-surface. The antenna A21 has a middle band section A21M that is a linear element for receiving the middle band signals, and a low band section A21L that is a linear element for receiving the low band signals. The low band section A21L and the middle band section A21M are electrically connected to each other at a predetermined position. Each of the low band section A21L and the middle band section A21M is formed in an L-shape. The low band section A21L has a portion along a main-front-edge E11 and another portion along the main-left-edge E14. The middle band section A21M has a portion parallel to the main-front-edge E11 and another portion parallel to the main-left-edge E14. The middle band section A21M is placed inward of the low band section A21L on the circuit board B1.

The middle band section A21M has an end facing in the X-axis positive direction and having a feeding point of the antenna A21. According to this configuration, a feeding direction of the antenna A21 is the same as an X-axis negative direction. The antenna A21 is configured to be able to receive the low band signals through a cooperation between the low band section A21L and a part of the middle band section A21M. The low band section A21L corresponds to an antenna element that shares the common feeding point with the middle band section A21M.

The antenna A21 corresponds to an antenna that is located farthest from a wireless circuit TRX1 among the antennas A21 to A25. Therefore, a signal line L21 that connects the feeding point of the antenna A21 to the wireless circuit TRX1 is longest in length among signal lines from the wireless circuit TRX1 to the respective antennas A21 to A25. Hereinafter, a length from a feeding point to the wireless circuit TRX1 is also abbreviated as a line length.

An antenna A22 is a triple band antenna that is configured to transmit and receive radio waves in the low band, the middle band, and the high band. For example, the antenna A22 is standing on the printed board B1 at a corner between the main-front-edge E11 and the main-right-edge E13 on the antenna-mounted-surface, by using a support portion S1. The support portion S1 has a rectangular parallelepiped shape. The support portion S1 is arranged along the main-front-edge E11 and the main-right-edge E13. The support portion S1 is made of resin, for example. For example, a length of the support portion S1 in the Y-axis direction is set to correspond to 0.22λH or more. A height of the support portion S1 is set to correspond to 0.25λH.

The antenna A22 extends along an outer surface of the support portion S1 from a side surface of the support portion S1 facing in the X-axis negative direction to an upper surface of the support portion S1. The antenna A22 is bent at right angle at an edge of the upper surface of the support portion S1. For example, the antenna A22 is continuously patterned on the side surface facing in the X-axis negative direction and the upper surface.

The antenna A22 has a configuration in which a high band section A22H, a middle band section A22M, and a low band section A22L are combined. The high band section A22H is an element for transmitting and receiving the high band signals. The middle band section A22M is a linear element for transmitting and receiving the middle band signals. The low band section A22L is a linear element for transmitting and receiving the low band signals. As shown in FIGS. 18 and 19, the middle band section A22M is electrically connected with the high band section A22H and the low band section A22L at predetermined positions.

The high band section A22H extends parallel to a Z-axis positive direction from a lower end of the support portion S1. The high band section A22H is formed linearly to have an electrical length of λH/4. Among the high band section A22H, the middle band section A22M, and the low band section A22L, the high band portion A22H is arranged outermost in a Y-axis negative direction. The high band section A22H corresponds to a high frequency antenna element.

Each of the middle band section A22M and the low band section A22L has an upright section that is extending in the Z-axis positive direction along the side surface of the support portion S1, and a floating section that is extending along the upper surface of the support portion S1 so as to face the antenna-mounted-surface. The floating section of each of the middle band section A22M and the low band section A22L includes an X-axis parallel portion that is extending in the X-axis positive direction from an upper end of the upright section, and a Y-axis parallel portion that is extending in the Y-axis negative direction from an end of the X-axis parallel portion that faces in the X-axis positive direction. A total length of the middle band section A22M is set to λM/4. The antenna A22 is configured to be able to transmit and receive the middle band signals through a cooperation between the middle band section A22M and a part of the high band section A22H.

A total length of the low band section A22L is set to λL/4. The antenna A22 is configured to be able to transmit and receive the low band signals through a cooperation among the low band section A22L, a part of the middle band section A22M and a part of the high band section A22H. The low band section A22L and the middle band section A22M correspond to antenna elements that share a common feeding point with the high band section A22H. The low band section A22L corresponds to a low frequency antenna element.

A feeding point of the antenna A22 is arranged at a bottom part of an upright section of the high band section A22H. In other words, the feeding point of the antenna A22 is located on the printed board B1. According to this configuration, a feeding direction of the antenna A22 is the same as the Z-axis positive direction. As will be described later, the antenna A22 corresponds to an antenna that is arranged closest to the wireless circuit TRX1 among the antennas A21 to A25. Therefore, a signal line L22 that connects the feeding point of the antenna A22 to the wireless circuit TRX1 is shortest in length among the signal lines from the wireless circuit TRX1 to the respective antennas A21 to A25. Further, the antenna A22 corresponds to a tallest antenna among the antennas A21 to A25.

The above configuration corresponds to a configuration in which the antennas for the high band, the middle band, and the low band are arranged near the wireless circuit TRX1 while sharing the common feeding point. According to this configuration, it is possible to obtain a sufficient signal quality not only at the high band but also at the relatively lower band. Moreover, the above configuration corresponds to a configuration in which an antenna closest to the wireless circuit TRX1 is used for transmission only, or for both transmission and reception. Since a number of antennas used for transmission is smaller than that of antennas for reception, this configuration makes it easier to ensure a quality of transmission signals.

The antenna A23 is a single band antenna configured to transmit and receive the high band radio waves. For example, the antenna A23 is arranged at a position shifted from the support portion S1 in the X-axis negative direction on the antenna-mounted-surface. The antenna A23 is formed in an L-shaped pattern. The antenna A23 includes a Y-axis parallel portion that is parallel to the Y-axis, and an X-axis parallel portion that extends in the X-axis negative direction from an end of the Y-axis parallel portion facing in a Y-axis positive direction. A total length of the antenna A23 is set to λH/4. A feeding point of the antenna A23 is arranged at an end of the Y-axis parallel portion facing in the Y-axis negative direction. According to this configuration, a feeding direction of the antenna A23 is the same as the Y-axis positive direction. A distance between the feeding point of the antenna A23 and the feeding point of the antenna A22 may be less than the coupling distance because these feeding directions are perpendicular to each other.

As described below, the antenna A23 corresponds to an antenna that is arranged second closest to the wireless circuit TRX1 among the antennas A21 to A25. Therefore, a signal line L23 that connects the feeding point of the antenna A23 to the wireless circuit TRX1 is second shortest in length among the signal lines from the wireless circuit TRX1 to the respective antennas A21 to A25. Moreover, this configuration corresponds to a configuration in which an antenna close to the wireless circuit TRX1 is used for transmission only or for both transmission and reception. As described above, since a number of antennas used for transmission is smaller than that of antennas for reception, this configuration makes it easier to ensure a quality of transmission signals.

The antenna A24 is a single band antenna used for reception only and supporting the high band. The antenna A24 is arranged at a position shifted from the antenna A23 in the X-axis negative direction. The antenna A24 is formed in an L-shaped pattern. The antenna A24 includes a Y-axis parallel portion that is parallel to the Y-axis, and an X-axis parallel portion that is extending in the X-axis positive direction from an end of the Y-axis parallel portion facing in the Y-axis positive direction. A total length of the antenna A24 is set to correspond to λH/4. Y-axis parallel portions of the antennas A24 and A23 are separated by the coupling distance or more.

A feeding point of the antenna A24 is arranged at an end of the Y-axis parallel portion facing in the Y-axis negative direction. According to this configuration, a feeding direction of the antenna A24 is the same as the Y-axis positive direction. The antennas A23 and A24 are the same in feeding direction, but the distance between them is greater than or equal to the coupling distance. Hence, a correlation value of these antennas can be reduced to 0.1 or less.

A signal line L24 that connects the feeding point of the antenna A24 to the wireless circuit TRX1 is second longest in length among the signal lines from the wireless circuit TRX1 to the respective antennas A21 to A25. In other words, the antenna A24 is shorter in the line length than the antenna A21 that is used for the middle band and the low band. This configuration corresponds to a configuration in which the antennas A21 to A25 are arranged so that a high frequency antenna is shorter than a low frequency antenna in the line length. A high frequency signals have a larger line loss than a low frequency signals. According to above configuration, it can be easier to obtain a sufficient communication quality in the high band.

The antenna A25 is a single band antenna used for reception only, and supporting the high band. The antenna A25 is arranged at a position shifted from the antenna A22 in the Y-axis negative direction on the side surface of the support portion S1 facing in the X-axis negative direction. The antenna A25 extends parallel to the Z-axis positive direction from the lower end of the support portion S1. A total length of the antenna A25 is set to correspond to λH/4. The antenna A25 and the high band section A22H of the antenna A22 are arranged apart from each other by at least the coupling distance in the Y-axis direction. That is, the distance between feeding points of antennas A22 and A25 is greater than or equal to the coupling distance.

A feeding point of the antenna A25 is arranged at an end of the antenna A25 facing in the Z-axis negative direction. In other words, the feeding point of the antenna A25 is located on the printed board B1. According to this configuration, a feeding direction of the antenna A25 is the same as the Z-axis positive direction. The antennas A25 and A22 are the same in feeding direction, but the distance between them is greater than or equal to the coupling distance. Hence, a correlation value of these two antennas can be reduced to 0.1 or less.

A signal line L25 that connects the feeding point of the antenna A25 to the wireless circuit TRX1 is third shortest in length among the signal lines from the wireless circuit TRX1 to the respective antennas A21 to A25. In other words, the antenna A25 is shorter in the line length than the antenna A21 that is used for the middle band and the low band. This configuration makes it easier to obtain the sufficient communication quality in the high band.

An antenna A26 is a component corresponding to the antenna A5 described above. The antenna A26 is arranged at a position shifted from the power supply circuit Cp or the interface circuit Ci in the Y-axis positive direction on the antenna-mounted-surface. The antenna A26 may be positioned at a predetermined distance or more from each of the antenna A22 and A25 having a three-dimensional structure provided by the support portion S1, so that the antenna A26 is exposed to the sky above.

The wireless circuit TRX1 is electrically connected to each of the antennas A21 to A25. The wireless circuit TRX1 is located at a position shifted from the antennas A22 and A25 in the X-axis negative direction and shifted from the antennas A23 and A24 in the Y-axis negative direction, on the back surface of the printed board B1. This configuration, from another view point, corresponds to a configuration in which antennas A22, A23, A24, A25 supporting the high band are arranged around the wireless circuit TRX1. More specifically, this configuration corresponds to a configuration in which the antennas A22, A23, A24, A25 for the high band are arranged within a predetermined distance (e.g., λH/4) from the wireless circuit TRX1. Furthermore, from another point of view, this arrangement configuration corresponds to a configuration in which the antennas A22 to A25 supporting the high band are located closer to the wireless circuit TRX1 than the antenna A21 supporting the low band is.

The above arrangement of the wireless circuit TRX1 is just an example, and the wireless circuit TRX1 may be arranged at a position overlapping the support portion S1 on the back surface of the printed board B1. Moreover, the wireless circuit TRX1 may be arranged at a position where a total value of line lengths for the respective antennas A21 to A25 is minimized. The wireless circuit TRX1 may be arranged at a location corresponding to a center of gravity of feeding points of the antennas A21 to A25. According to the above configuration, line losses can be reduced.

A wireless circuit TRX2 is a circuit for processing signals received from the satellites via the antenna A26. The wireless circuit TRX2 is arranged behind the antenna A26.

### Overview of Third Embodiment

According to the above configuration, the vehicular communication device 1 has antennas A21 and A22 as antennas which can transmit and/or receive the low band signals. That is, the vehicular communication device 1 has two low band antennas. Further, the vehicular communication device 1 has antennas A21 and A22 as antennas which can transmit and/or receive the middle band signals. That is, the vehicular communication device 1 has two middle band antennas. Moreover, the vehicular communication device 1 has antennas A22 to A25 as antennas which can transmit and/or receive the high band signals. That is, the vehicular communication device 1 has four high band antennas, i.e. antennas A22 to A25.

This configuration corresponds to a configuration in which a number of antennas increases with increase in frequency. It also corresponds to a configuration in which a number of antennas supporting a highest band is biggest. Qualitatively, as a frequency is higher, a line loss increases, signals are more attenuated, and a communication performance deteriorates. The above configuration has been created focused on this problem. In this configuration, the vehicular communication device 1 has more antennas for the high band than antennas for the low band, it becomes easier to obtain a required communication performance.

Further, antennas A22 and A23 used for signal transmission are arranged closer to the wireless circuit TRX1 than the antenna A24 that is used for reception only and operates at the same band as the antennas A22 and A23 is. According to this configuration, it is possible to reduce signal losses in the transmission process.

Further, since the feeding directions of the antennas A22 and A23 are perpendicular to each other, the distance between these antennas may be set to less than the coupling distance while reducing the correlation value to 0.1 or less. Further, since the feeding directions of the antennas A22 and A21 are perpendicular to each other, the distance between these antennas may be set to less than the coupling distance while reducing the correlation value to 0.1 or less. That is, multiple antennas can be densely mounted while maintaining a good performance of communication using multiple antennas.

In addition, antennas A21 and A25 correspond to antennas erected vertically on the printed board B1. When the vehicular communication device 1 is attached on the vehicle with the printed board B1 being substantially horizontal to the ground, the antenna A25 functions as a monopole antenna generally perpendicular to the ground. Moreover, since positions of the antennas A21 and A25 are relatively high, the communication quality can be improved. According to the above configuration, the same effects as those of the first embodiment and the second embodiment can be obtained.

The above configuration is created based on the following design ideas (3), (4), (5), (6) in addition to the design ideas (1), (2) described above. A configuration designed according to these design ideas can reduce a correlation value between antennas.

Idea (3): Each antenna is arranged so that a relatively high frequency antenna is shorter than a relatively low frequency antenna in signal line connecting a feeding point of the antenna to the wireless circuit TRX1. In other words, the high frequency antenna is arranged closer to the wireless circuit TRX1 than the low frequency antenna is. Since a higher frequency generates a greater line loss, the above configuration can reduce a total line loss in the vehicular communication device 1. In addition, a configuration based on the idea (3) makes it easier to obtain the required communication quality in a relatively high band among bands that the vehicular communication device 1 supports. Here, the low band section A22L corresponds to the low frequency antenna, for example. The high band section A22H corresponds to the high frequency antenna, for example.

Idea (4): A feeding point of the high frequency antenna arranged close to the wireless circuit TRX1 is shared with the low frequency antenna. According to this configuration, the low frequency antenna can also be located close to the wireless circuit TRX1. This configuration corresponds to a configuration in which a multiband antenna which is an antenna configured to operate in multiple bands including the high band is located to be close to the wireless circuit TRX1.

Idea (5): an antenna that is used for transmission-only or both transmission and reception is located close to the wireless circuit TRX1. In the vehicular communication device 1, a number of antennas for transmission is often smaller than a number of antennas for reception. Hence, a margin of communication performance for signal transmission is not sufficient compared to that for signal reception. A transmission loss has a great influence on communication quality. Thus, locating an antenna for transmission close to the wireless circuit TRX1 can provide improvement in quality of transmission signals.

Idea (6): An antenna operating on the same principle as a monopole antenna is erected on the printed board B1 near the wireless circuit TRX1, and the antenna is set as a transmission-only antenna or a transmission and reception antenna. The radio base stations are often configured to transmit vertically polarized waves. When the vehicular communication device 1 is attached on the vehicle with the printed board B1 being substantially horizontal to the ground, the antenna described above functions as a monopole antenna generally perpendicular to the ground, thereby improving a quality of communication with the radio base stations.

Based on the above design ideas (1) to (6), even when changes in antenna positions and inter-antenna distances have been made at time of designing of the circuit layout, a great change of a communication performance can be reduced. As a result, an efficiency of the design process can be enhanced. In addition, the design ideas may include an idea that an antenna for satellite communication is arranged at a position away from a conductive three-dimensional structure such as the vehicle body or the printed board B1. According to this idea, it is possible to reduce a possibility of the satellite communication antenna having a radio blind spot.

### Fourth Embodiment

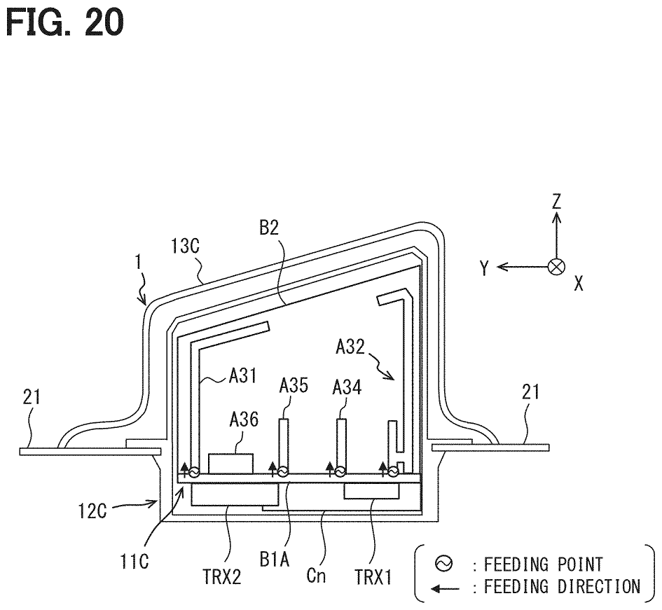

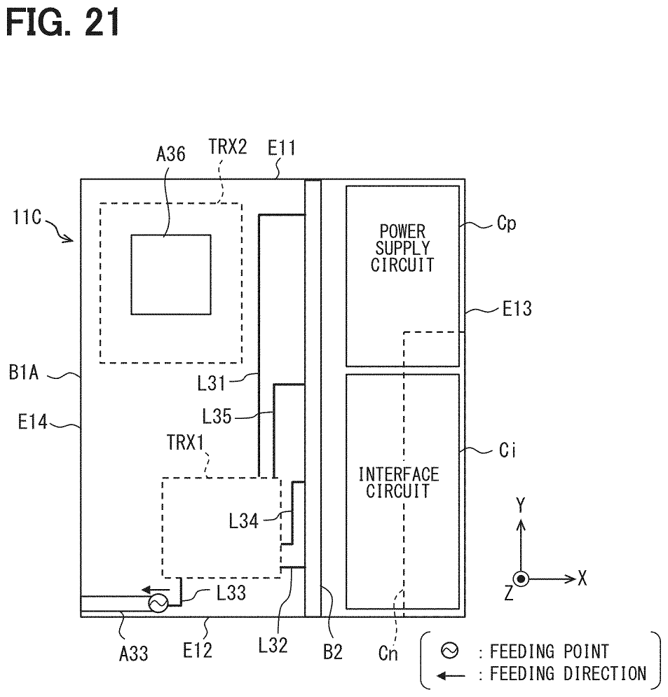

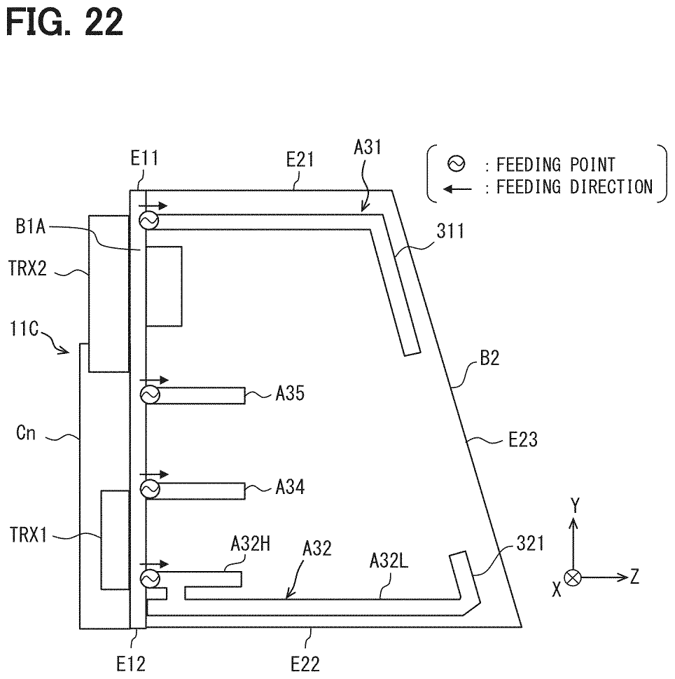

Hereinafter, a vehicular communication device 1 of a fourth embodiment of the present disclosure will be described with reference to FIGS. 20 to 22. FIG. 20 is a diagram showing a state in which the vehicular communication device 1 mounted on a roof of a vehicle, according to the fourth embodiment. FIG. 21 is a front view of a circuit board 11C according to the fourth embodiment, and FIG. 22 is a side view of the circuit board 11C according to the fourth embodiment. A fourth embodiment corresponds to a modification of the second embodiment. Furthermore, the fourth embodiment corresponds to a configuration combining the second embodiment and the third embodiment.

A difference between the fourth embodiment and the second embodiment is that the vehicular communication device 1 in the fourth embodiment is configured to be able to transmit and receive radio waves in multiple frequency bands. In other words, the vehicular communication device 1 in the fourth embodiment has multiple antennas with different operating frequencies.

Here, as an example, the vehicular communication device 1 is configured to be able to transmit/receive radio waves in two frequency bands: a high band, and a low band. The low band is a lower frequency band than the high band. For example, the low band may be set to the 1.5 GHz band. For example, the high band may be set to the 4.5 GHz band. As in the third embodiment, λH represents a wavelength of radio waves in the high band, and λL represents a wavelength of radio waves in the low band.

As shown in FIG. 20, the vehicular communication device 1 in the fourth embodiment includes the circuit board 11C, a housing 12C, and a cover 13C. Configurations of the housing 12C and the cover 13C may be the same configurations as the housing 12A and the cover 13A of the second embodiment.

As shown in FIG. 21, the circuit board 11C includes a main-board B1A corresponding to the printed board B1, a sub-board B2, antennas A31, A32, A33, A34, A35, wireless circuits TRX1, TRX2, a vehicle connector Cn, an interface circuit Ci, and a power supply circuit Cp.

An electrical length of the main-board B1A in an X-axis direction is set to 0.25λL, and a length thereof in a Y-axis direction is set to correspond to 0.3λL. The dimensions of the main-board B1A can be changed as appropriate. The length in the Y-axis direction of the main-board B1A may be set to 0.22λL or more.

The sub-board B2 is a printed board attached perpendicularly to the main-board B1A. The sub-board B2 is attached to the antenna-mounted-surface in an orientation parallel to a YZ plane. For example, a position of the sub-board B2 in the X-axis direction on the antenna-mounted-surface can be a position shifted by a predetermined distance from a center of the antenna-mounted-surface. Of course, the position of the sub-board B2 in the X-axis direction on the antenna-mounted-surface may be a position passing through a center of the antenna-mounted-surface. The sub-board B2 is formed so that its length in the Z-axis direction increases from an end portion facing in a Y-axis positive direction toward another end portion facing in a Y-axis negative direction.

A length of the sub-board B2 in the Y-axis direction is set to the same as that of the main-board B1A. A sub-front-edge E21 is aligned with a main-front-edge E11, and a sub-rear-edge E22 is aligned with a main-rear-edge. The length of the sub-board B2 in the Y-axis direction may be set to shorter than that of the main-board B1A. However, in order to set a distance between antennas A31 and A32 equal to or greater than the coupling distance, the length of the sub-board B2 in the Y-axis direction may be set longer than 0.22λL. In addition, the end portion facing in the Y-axis positive direction and the end portion facing in the Y-axis negative direction are different in length of the sub-board B2 in a Z-axis direction, i.e. height of the sub-board B2. An electrical length of the sub-front-edge E21 is set to 0.15λL, for example. An electrical length of the sub-rear-edge E22 is set to 0.2λL, for example.

The vehicle connector Cn is arranged on a back surface of the main-board B1A such that an end of the vehicle connector Cn facing in a longitudinal direction of the vehicle connector Cn is aligned with a main-rear-edge E12 and that the vehicle connector Cn extends along a main-right-edge E13. The interface circuit Ci is arranged behind the vehicle connector Cn. The interface circuit Ci is arranged between the main-right-edge E13 and the sub-board B2 on the antenna-mounted-surface.

The power supply circuit Cp is arranged near the interface circuit Ci in the fourth embodiment. For example, the power supply circuit Cp is arranged between the main-right-edge E13 and the sub-board B2 on the antenna-mounted-surface, so as to be adjacent to the interface circuit Ci in the Y-axis direction. Illustrations of the interface circuit Ci and the power supply circuit Cp are omitted in the FIG. 22. This configuration correspond to a configuration in which the sub-board B2 is arranged adjacent to the power supply circuit Cp and the interface circuit Ci.

Antennas A31, A32, A33, A34, A35 are antennas for performing data communication with radio base stations that constitute a mobile communications system. Among the antennas A31 to A35, an antenna A31 is configured as a single band antenna that is used for reception only and supporting the low band. The antenna A31, for example, extends from a sub-lower-edge toward a sub-upper-edge E23 along the sub-front-edge E21 on a left-side-surface of the sub-board B2. In other words, the antenna A31 extends perpendicularly to the main-board B1A. Further, the antenna A31 has a shape bent in the Y-axis negative direction near the sub-upper-edge E23 so as to be along the sub-upper-edge E23. That is, the antenna A31 has an upright section extending along the sub-front-edge E21 from a joint portion with the main-board B1A, and an extended section 311 extending along the sub-upper-edge E23. A total length of the antenna A31 is set to λL/4. A feeding point of the antenna A31 is arranged at a bottom part of the upright section. In other words, the feeding point of the antenna A31 is located at an end of the antenna A31 facing in a Z-axis negative direction. According to this configuration, a feeding direction of the antenna A31 is the same as a Z-axis positive direction.

The antenna A31 corresponds to an antenna that is arranged farthest from a wireless circuit TRX1 among the antennas A31 to A35. Therefore, a signal line L35 that connects the feeding point of the antenna A31 and the wireless circuit TRX1 is longest in length among signal lines from the wireless circuit TRX1 to the respective antennas A31 to A35. However, since the antenna A31 receives relatively low frequency signals, line loss in the signal line L31 is relatively small.

The antenna A32 is a dual band antenna configured to transmit and receive radio waves in the high band and the low band. The antenna A32 is patterned along the sub-rear-edge E22 on the left-side-surface of the sub-board B2. The antenna A32 has a high band section A32H for transmitting and receiving the high band signals, and a low band section A32L that is a linear element for transmitting and receiving the low band signals. The high band section A32H and the low band section A32L are electrically connected to each other at a predetermined position.

The low band section A32L, for example, extends from the sub-lower-edge toward the sub-upper-edge E23 along the sub-rear-edge E22. In other words, the low band section A32L is extended perpendicularly to the main-board B1A. Further, the low band section A32L has a shape bent in the Y-axis positive direction near the sub-upper-edge E23 so as to be along the sub-upper-edge E23. In other words, the low band section A32L has an upright section extending along the sub-rear-edge E22 from the joint portion with the main-board B1A, and an extended section 321 extending along the sub-upper-edge E23. A total length of the low band section A32L is set to λL/4.

The high band section A32H is formed linearly at a position shifted from the low band section A32L in the Y-axis positive direction so as to be parallel to the upright section of the low band section A32L. In other words, the high band section A32H extends perpendicularly to the main-board B1A. An electrical length of the high band section A32H is set to λH/4. A feeding point of the antenna A32 is arranged at a bottom part of the high band section A32H. In other words, the feeding point of the antenna A32 is located at an end of the antenna A32 facing in the Z-axis negative direction. According to this configuration, a feeding direction of the antenna A32 is the same as the Z-axis positive direction. The antenna A32 is configured to be able to transmit and receive the low band signals through a cooperation between the low band section A32L and a part of the high band section A32H. The low band section A32L corresponds to an antenna element that shares the common feeding point with the high band section A32H.

Both antennas A31 and A32 are mounted on the sub-board B2, and their feeding directions are the same. However, the antenna A32 is arranged along the sub-rear-edge E22, and the antenna A31 is arranged along the sub-front-edge E21. Since the electrical length of the sub-board B2 in the Y-axis direction is set to 0.22λL or more, a distance between antennas A32 and A31 is also 0.22λL or more. According to this configuration, the correlation value between the antenna A32 and A31 can be reduced to 0.1 or less.

The antenna A32 corresponds to an antenna that is arranged to be closest to the wireless circuit TRX1 among the antennas A31 to A35, as described later. A signal line L32 that connects the feeding point of the antenna A32 and the wireless circuit TRX1 is shortest in length among the signal lines from the wireless circuit TRX1 to the respective antennas A31 to A35. Therefore, the antenna A32 corresponds to an antenna with a smallest line loss. Further, the antenna A32 corresponds to a tallest antenna among the antennas A31 to A35. Therefore, the antenna A32 corresponds to an antenna element arranged at the best position and orientation for reception and transmission of radio waves among the antennas A31 to A35. A configuration using the antenna A32 as a transmission and reception antenna for both transmitting and receiving radio waves in the low band and the high band makes easier to obtain a required quality of communication using multiple antennas.

The above configuration of the antenna A32 corresponds to a configuration in which an antenna for the high band and an antenna for the low band are arranged near the wireless circuit TRX1 so that they share a common feeding point. According to this configuration, it is possible to obtain a sufficient signal quality not only at the high band but also at the low band. The antenna A32 corresponds to an antenna arranged to satisfy the design ideas (3) to (6).

An antenna A33 is a single band antenna configured to transmit and receive the high band signals. The antenna A33 is arranged along the main-rear-edge E12. The antenna A33 is formed in a linear pattern to have an electrical length of λH/4. The antenna A33 has an end facing in an X-axis positive direction and having a feeding point of the antenna A33. According to this configuration, a feeding direction of the antenna A33 is the same as an X-axis negative direction.

The feeding direction of the antenna A33 is perpendicular to that of the antenna A32, which is the closest antenna to the antenna A33. Therefore, a distance between feeding points of antennas A33 and A32 may be less than the coupling distance. That is, the antenna A33 may be arranged closer to the sub-board B2 than a position shown in the FIG. 21. Further, an extending direction of the antenna A33 may be parallel to the Y-axis direction. For example, the antenna A33 may be arranged along the main-left-edge E14. In this case, the feeding direction of the antenna A33 is the same as the Y-axis positive direction or the Y-axis negative direction. When the feeding direction of the antenna A33 is the same as the Y-axis positive/negative direction, the feeding direction of the antenna A33 is perpendicular to that of other antennas including the antenna A32. Hence, the correlation value between the antenna A33 and the other antennas can be reduced to 0.1 or less.

The antenna A33 corresponds to an antenna that is arranged second closest to the wireless circuit TRX1 among the antennas A31 to A35. A signal line L33 that connects the feeding point of the antenna A33 and the wireless circuit TRX1 is second shortest in length among the signal lines from the wireless circuit TRX1 to the respective antennas A31 to A35. Therefore, the antenna A33 corresponds to an antenna having a second smallest line loss among the antennas A31 to A35. The antenna A33 corresponds to an antenna that satisfies design ideas (3) and (5) described above.

The antenna A34 is a single band antenna that is used for reception only and configured to receive the high band signals. The antenna A34 extends from the sub-lower-edge along the Z-axis positive direction, at a position shifted by 0.22λH or more from the high band section A32H of the antenna A32 in the Y-axis positive direction on the left-side-surface of the sub-board B2. In other words, the antenna A34 extends perpendicularly to the main-board B1A. The antenna A34 is formed linearly to have a length of λH/4. The antenna A34 has an end facing in the Z-axis negative direction and having a feeding point of the antenna A34. According to this configuration, a feeding direction of the antenna A34 is the same as the Z-axis positive direction. The antennas A32 and A34 are the same in feeding direction, but the distance between the feeding point of each of them is 0.22λH or more. Hence the correlation value of them can be reduced to 0.1 or less.

The antenna A34 corresponds to an antenna that is arranged third closest to the wireless circuit TRX1 among the antennas A31 to A35. Therefore a signal line L34 that connects the feeding point of the antenna A34 and the wireless circuit TRX1 is third shortest in length among the signal lines from the wireless circuit TRX1 to the respective antennas A31 to A35. However, since the antenna A34 is erected on the main-board B1A, the antenna A34 has an orientation suitable for receiving radio waves from the radio base stations while the vehicular communication device 1 being attached to the vehicle. The antenna A34 corresponds to an antenna arranged to satisfy design ideas (3) and (6) described above.

The antenna A35 is a single band antenna used for reception only and configured to receive the high band radio waves. The antenna A35 extends from the sub-lower-edge along the Z-axis positive direction, at a position shifted by 0.22λH or more from the antenna A34 in the Y-axis positive direction on the left-side-surface of the sub-board B2. In other words, the antenna A35 extends perpendicularly to the main-board B1A. The antenna A35 is formed linearly to have a length of λH/4. The antenna A35 has an end facing in the Z-axis negative direction and having a feeding point of the antenna A35. According to this configuration, a feeding direction of the antenna A35 is the same as the Z-axis positive direction. The antennas A34 and A35 are the same in feeding direction, but a distance between their feeding points is 0.22λH or more, so the correlation value can be reduced to 0.1 or less.

The antenna A35 corresponds to an antenna that is arranged second farthest from the wireless circuit TRX1 among the antennas A31 to A35. However, the antenna A35 is closer to the wireless circuit TRX1 than the antenna A31 for the low band is. This configuration corresponds to a configuration in which the antenna A35 for the high band is arranged closer to the wireless circuit TRX1 than the antenna A31 for the low band is. Further, since the antenna A35 is erected on the main-board B1A, the antenna A35 has an orientation suitable for receiving radio waves from the radio base stations while the vehicular communication device 1 being attached to the vehicle. The antenna A35 corresponds to an antenna arranged to satisfy design ideas (3) and (6) described above.

An antenna A36 is a component corresponding to the antenna A5. The antenna A36 is arranged at a position shifted from the sub-board B2 in the X-axis negative direction on the antenna-mounted-surface of the main-board B1A. For example, the antenna A36 is arranged at a position that is shifted from a center of the main-board B1A in both the X-axis negative direction and the Y-axis positive direction. The antenna A36 may be located at a position that is shifted in the X-axis negative direction from the sub-board B2 and in a central portion of the main board in the Y-axis direction. According to this configuration, distances from the antenna A36 to the antennas A31 and A32, which are the first and second tallest among the antennas A31 to A35, can be set longer, thereby reducing a blind spot of the antenna A36.

The wireless circuit TRX1 is electrically connected to each of the antennas A31 to A35. The wireless circuit TRX1 is arranged at a position that is shifted in the X-axis negative direction from the antennas A32 and A34 and in the X-axis positive direction from the antennas A33 on the back surface of the printed board B1. In other words, the wireless circuit TRX1 is located between the antenna A32 and the antenna A33. This arrangement is corresponding to an arrangement in which antennas A32, A33, and A34 are arranged in a vicinity area of the wireless circuit TRX1. The vicinity area of the wireless circuit TRX1 means an area within a predetermined distance (e.g., λH/4) from the wireless circuit TRX1. The above arrangement of the wireless circuit TRX1 is just an example, and the wireless circuit TRX1 may be arranged at a position overlapping the sub-board B2 on the back surface of the printed board B1. Moreover, the wireless circuit TRX1 may be arranged at a position where a total value of line lengths from the wireless circuit TRX1 to the respective the antennas A31 to A35 is minimized. The wireless circuit TRX1 may be arranged at a location corresponding to a center of gravity of feeding points of the antennas A31 to A35. According to the above configuration, line losses can be reduced.

A wireless circuit TRX2 is a circuit for processing signals received from the satellites via the antenna A36. The wireless circuit TRX2 is arranged behind the antenna A36.

### Overview of Fourth Embodiment

According to the above configuration, the vehicular communication device 1 has antennas A31, A32 as antennas which can transmit and/or receive the low band signals. That is, the vehicular communication device 1 has two low band antennas. Moreover, the vehicular communication device 1 has antennas A32, A33, A34, A35 as antennas which can transmit and/or receive the high band signals. That is, the vehicular communication device 1 has four high band antennas, i.e. antennas A32 to A35.

This configuration corresponds to a configuration in which the number of the high band antennas is more than the number of the low band antennas. As described above, a line loss tends to increase and a communication performance tends to decrease with increase in frequency. The configuration described above has been created focused on this problem. According to this configuration, since the number of the high band antennas is more than the low band antennas, it becomes easier to obtain a required communication performance. Furthermore, the antennas A32, A33 used for signal transmission are arranged close to the wireless circuit TRX1. According to this configuration, line losses in signal transmission can be reduced.

The feeding directions of the antennas A32, A33 are perpendicular to each other. Therefore, even if the distance between these antennas is set to less than the coupling distance, the correlation value between these antennas can be reduced to 0.1 or less. That is, the performance of communication using multiple antennas can be maintained satisfactorily. Further, since the feeding directions of the antennas A33 and A34 are perpendicular to each other, the distance between these antennas may be set to less than the coupling distance while reducing the correlation value to 0.1 or less. As a result, it is possible to downsize the vehicular communication device 1.

In addition, antennas A31, A32, A34, A35 correspond to antennas erected vertically on the main-board B1A. When the vehicular communication device 1 is attached on the vehicle with the main-board B1A substantially horizontal to the ground, these antennas function as monopole antennas that are generally perpendicular to the ground. That is, each of the antennas A31, A32, A34, A35 function as an antenna receiving vertically polarized waves and having an omnidirectional horizontal orientation. Further, these antennas A31, A32, A34, A35 correspond to antennas taller than the antenna A33. According to this configuration, it becomes easy to obtain the required communication quality. In addition, since the vehicular communication device 1 has multiple monopole antennas perpendicular to the main-board B1A, the performance of a communication system using multiple antennas, such as the MIMO system, is improved. Furthermore, according to the above configuration, the same effects as those of the first embodiment and the second embodiment can be obtained.

While the embodiments of the present disclosure have been described above, the present disclosure is not limited to these embodiments. In addition, various modifications other than those described above are possible without departing from the spirit of the present disclosure. For example, various embodiments described above can be executed in combination as appropriate within a scope that does not cause technical inconsistency. Further, the following configurations are also included in the scope of the present disclosure.

Although in configurations disclosed above, an antenna for mobile communication is implemented by a monopole antenna, the vehicular communication device 1 may have a patch antenna, an inverted F antenna, or a loop antenna as an antenna for mobile communication. A feeding direction for a flat plate antenna corresponds to an extending direction of its radiating element at a feeding point.

In the above description, the design ideas (1), (2), (3), (4), (5), (6) are applied to determination of a layout of antennas for mobile communications such as 5G and 4G, but these design ideas can be applied to other applications. For example, if the vehicular communication device 1 has multiple antennas for V2X communication, the design ideas (1) to (6) can be applied to determination of a layout of those antennas. Part or all of the design ideas (1) to (6) may be applied to determination of an arrangement of multiple antennas used for different uses. For example, the antenna A1 may be a an antenna for Bluetooth, the antennas A2 and A3 may be antennas for 4G, and the antenna A4 may be an antenna for Wi-Fi.

The back surface of the printed board B1 corresponds to a surface facing to the vehicle compartment. An antenna module for Bluetooth and/or Wi-Fi may be arranged on the back surface of the printed board B1. According to such a configuration, the vehicular communication device 1 can have a function for performing wireless communication with a smartphone or the like brought into the vehicle by a user.

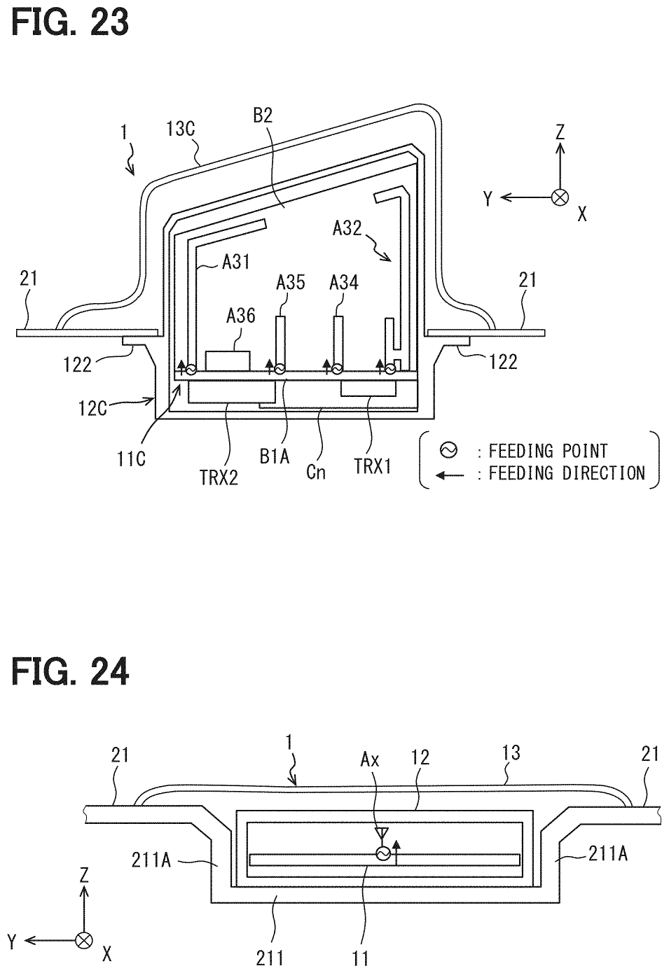

When the vehicular communication device 1 has a configuration including the sub-board B2 such as the second and fourth embodiments, the vehicular communication device 1 may be attached to the vehicle so that the main-board B1A is located under the roof 21 and only configurations associated with the sub-board B2 protrude upward from the roof 21, as shown in FIG. 23. The configurations associated with the sub-board B2 includes antennas mounted on the sub-board B2, and the housing that accommodates the sub-board B2. According to the attachment state described above, a size of a hole provided in the roof 21 can be reduced. A part of the sub-board B2 protruding upward from the roof 21 is configured to be protected by the housing 12 and the cover 13. In the vehicular communication device 1 shown in FIG. 23, an overhang portion 122 that protrudes sideways from an upper surface of the housing 12 may be fixed to the roof 21 with adhesives, screws, or the like.

In the above description, as an example of an attachment state of the vehicular communication device 1 attached on the vehicle 2, a hole for fitting the vehicular communication device 1 is provided in the roof 21, and the vehicular communication device 1 is fitted into the hole. However, the attachment state is not limited to this. As shown in FIG. 24, a recess 211 may be provided in the roof 21 of the vehicle 2, and the vehicular communication device 1 may be fixed to the recess 211. Various methods can be used to secure the vehicular communication device 1 in the recess 211, such as screwing or gluing.

In addition, in a configuration in which the vehicular communication device 1 is arranged in the recess 211, a transmission and reception antenna Ax may be arranged in the central portion of the printed board B1 or the main-board B1A. If the transmission and reception antenna Ax is arranged on an edge of the printed board B1, a blind spot of the transmission and reception antenna Ax becomes relatively large due to metal members forming a step 211A of the recess 211. On the other hand, according to a configuration in which the transmission and reception antenna Ax is arranged in the central portion of the printed board B1 or the main-board B1A, the blind spot of the transmission and reception antenna Ax can be reduced, and a required communication performance can be easily achieved. The transmission and reception antenna Ax may be erected on the printed board B1 or the main-board B1A based on the design idea described above. The transmission and reception antenna Ax shown in FIG. 24 corresponds to the antennas A2, A12, A22, A32, and the like.

In addition, in a configuration in which the vehicular communication device 1 is arranged in the recess 211, an antenna element may be patterned on an inner upper surface of the housing 12. According to this configuration, the antenna element can be arranged at a highest position in the device, and hence the blind spot caused by the step 211A of the recess 211 can be reduced. In that vehicular communication device 1, an end of the antenna element arranged on the inner upper surface of housing 12 may contact a feeding point provided on the printed board B1. For example, a resin block having a height so as to contact the antenna element arranged on the inner upper surface of the housing 12 may be arranged on the printed board B1, and the feeding point may be arranged on the upper surface of the resin block.

The vehicular communication device 1 does not necessarily have to have a combination of antennas whose feeding directions are perpendicular to each other. The vehicular communication device 1 may be configured according to only some of the design ideas (1) to (6). For example, the vehicular communication device 1 can be configured according to the design ideas (3) to (6).

Each of antennas A1, A3, A4, A11, A13, A21, A23, A24, and A33 corresponds to a parallel feeding antenna. Each of antennas A2, A12, A14, A22, A25, A31, A32, A34, and A35 corresponds to a vertical feeding antenna.

Each of antennas A2, A12, A22, A23, and A33 corresponds to a transmission and reception antenna. Each of antennas A1, A3, A4, A11, A13, A14, A21, A24, A25, A31, A34, and A35 corresponds to a reception-only antenna. Each of antennas A5, A15, A26, and A36 corresponds to a satellite antenna.

The high band or the middle band corresponds to a second frequency band. When considering the high band as the second frequency band, at least one of the middle band and the low band corresponds to a first frequency band. In addition, when considering the low band as the first frequency band, at least one of the high band and middle band corresponds to the second frequency band. For example, each of antennas A22, A23, A24, A25, A32, A33, A34, and A35 corresponds to a second frequency antenna. Antennas A21 and A31 correspond to first frequency antennas. Each of antennas A21, A22 and A32 corresponds to a multiband antenna, and each of antennas A23, A24, A25, A31, A33, A34 and A35 corresponds to a single band antenna. A dual band antenna and/or a triple band antenna corresponds to a multiband antenna.

<Additional Notes>

The present disclosure also includes the following various configurations.

### Configuration (1)

A vehicular communication device includes antennas and a wireless circuit. An antenna located farthest in electrical distance from the wireless circuit among the antennas is not an antenna operating in a highest frequency band among the antennas.

### Configuration (2)

A vehicular communication device includes antennas and a wireless circuit. An antenna located farthest in electrical distance from the wireless circuit among the antennas is a reception-only antenna.

### Configuration (3)

A vehicular communication device includes antennas and a wireless circuit. The antennas include a multi band antenna (A22, A32) that is configured to operate in multiple frequency bands, and a single band antenna (A23, A24, A25, A31, A33, A34, A35) that is configured to operate in one frequency band. An antenna located farthest in electrical distance from the wireless circuit among the antennas is the single band antenna.

### Configuration (4)

A vehicular communication device includes antennas and a wireless circuit. The antennas include a multiband antenna (A22, A32) that is configured to operate in multiple frequency bands, and a single band antenna (A23, A24, A25, A31, A33, A34, A35) that is configured to operate in one frequency band. An antenna element located closest in electrical distance to the wireless circuit among the antenna elements is the multi-band antenna.

### Configuration (5)

A vehicular communication device is configured to be used by being attached to a hole provided in a roof of a vehicle.

### Configuration (5λ)

The vehicular communication device according to the configuration (5), includes a resin housing (12, 12λ, 12B, 12C). The resin housing has a fitting groove (121) for fitting with an edge of the hole provided in the roof. The fitting groove is formed in an upper end portion of a side surface of the resin housing.

### Configuration (6λ)

A vehicular communication device is configured to be used by being attached to a recess (211) provided in a roof of a vehicle.

### Configuration (6)

The vehicular communication device according to the configuration (6), includes an antenna element that is used for both transmission and reception and arranged at a central portion of a substrate. According to this configuration, it is possible to reduce a blind spot of the antenna caused by a step of the recess.

### Configuration (6B)

The vehicular communication device according to the configuration (6), includes a substrate having a rectangular shape. Antenna elements are arranged on at least three of four edges of the substrate. According to this configuration, a blind spot of an antenna element arranged on one edge, caused by a step of the recess, can be eliminated by an antenna element arranged on another edge.

### Configuration (6C)

The vehicular communication device according to the configuration (6), includes an antenna element pattern-formed on an inside top surface of a housing that accommodates a substrate. According to this configuration, an antenna can be arranged at a highest position in the device, so that a blind spot caused by a step of the recess can be reduced.

### Configuration (7)

A vehicular communication device includes antenna elements for mobile communication. Each of the antenna elements is pattern-formed in an area adjacent to a different edge of a printed board. According to this configuration, an inter-antenna distance can be set larger, and a correlation value can be further reduced.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A vehicular communication device mounted on a vehicle, comprising:
antenna elements; and
a wireless circuit connected to the antenna elements and performing communication with another device using the antenna elements, wherein
each antenna element of the antenna elements has a feeding point and a feeding direction in which the antenna element extends from the feeding point,
the antenna elements include two antenna elements that are separated by a distance less than a predetermined coupling distance, and
feeding directions of the two antenna elements are perpendicular to each other.

2. The vehicular communication device according to claim 1, wherein
the coupling distance is 0.22λ.

3. The vehicular communication device according to claim 1, further comprising
an opposed substrate parallel to a mounting surface of the vehicle, wherein
the antenna elements include:
a parallel feeding antenna that is an antenna element having a feeding direction parallel to the opposed substrate; and
a vertical feeding antenna that is an antenna element having a feeding direction perpendicular to the opposed substrate.

4. The vehicular communication device according to claim 3, wherein
the vertical feeding antenna is a linear element having a bent shape.

5. The vehicular communication device according to claim 3, wherein
the antenna elements include:
a reception-only antenna that is an antenna element used for reception only; and
a transmission and reception antenna that is an antenna element used for both transmission and reception, and
one of the antenna elements located closest to the wireless circuit among the antenna elements is the vertical feeding antenna functioning as the transmission and reception antenna.

6. The vehicular communication device according to claim 3, further comprising
a satellite antenna that is different from the antenna elements and is mounted on the opposed substrate to receive signals from a satellite, wherein
the satellite antenna is positioned at a predetermined distance or more from the vertical feeding antenna.

7. The vehicular communication device according to claim 3, wherein
the opposed substrate has a pre-defined front-rear direction that corresponds to a front-rear direction of the vehicle,
the vehicular communication device comprises a vertical plate provided along the front-rear direction of the opposed substrate and perpendicular to the opposed substrate,
the antenna elements include:
a first frequency antennas that is an antenna element operating in a first frequency band; and
a second frequency antenna that is an antenna element operating in a second frequency band that is higher than the first frequency band,
the vertical plate has a height that increases in the front-rear direction from a front end to a rear end of the vertical plate,
the first frequency antenna is located at each of the front end the rear end of the vertical plate, and the second frequency antenna is located between the front end the rear end.

8. The vehicular communication device according to claim 3, wherein
the antenna elements include a transmission and reception antenna that is an antenna element used for both transmission and reception, and
the transmission and reception antenna stands on the opposed substrate.

9. The vehicular communication device according to claim 3, wherein
the opposed substrate has a pre-defined right-left direction that corresponds to a right-left direction of the vehicle,
the vehicular communication device comprises a connector that is connected to a communication cable,
the opposed substrate has a back surface that is opposite from a surface on which the vertical feeding antenna is located, and
the connector is mounted on the back surface and arranged along a right edge or a left edge of the back surface of the opposed substrate.

10. The vehicular communication device according to claim 1, wherein
the antenna elements include:
a first frequency antenna that is an antenna element operating in a first frequency band; and
a second frequency antenna that is an antenna element operating in a second frequency band that is higher than the first frequency band, and
the second frequency antenna is located closer to the wireless circuit than the first frequency antenna is.

11. The vehicular communication device according to claim 1, wherein
the antenna elements operate in different frequency bands, and
an antenna element located closest to the wireless circuit among the antenna elements operates in a highest frequency band.

12. The vehicular communication device according to claim 1, wherein
the antenna elements include:
at least one first frequency antenna that is an antenna element operating in a first frequency band; and
at least one second frequency antenna that is an antenna element operating in a second frequency band that is higher than the first frequency band, and
a number of the at least one second frequency antenna is larger than a number of the at least one first frequency antenna.

13. The vehicular communication device according to claim 1, wherein
the antenna elements include:
a reception-only antenna that is an antenna element used for reception only; and
a transmission and reception antenna that is an antenna element used for both transmission and reception, and
the reception-only antenna and the transmission and reception antenna operate in the same frequency band, and
the transmission and reception antenna is located closer to the wireless circuit than the reception-only antenna is.

14. The vehicular communication device according to claim 1, wherein
the antenna elements include:
a first frequency antenna that is a linear element operating in a first frequency band; and
a second frequency antenna that is a linear element operating in a second frequency band which is higher than the first frequency band, and
the first frequency antenna has a bent shape while the second frequency antenna has a straight shape.
